(19) United States
(12) Patent Application Publication
(10) Pub. No.: US 2026/0099110 A1
(43) Pub. Date: Apr. 9, 2026

(54) PROCESS UNIT AND IMAGE FORMING APPARATUS

(71) Applicant: CANON KABUSHIKI KAISHA, Tokyo (JP)

(72) Inventors: MITSUHIRO SATO, Tokyo (JP); HIROYUKI MUNETSUGU, Kanagawa (JP)

(21) Appl. No.: 19/351,660

(22) Filed: Oct. 7, 2025

(30) Foreign Application Priority Data
Oct. 9, 2024 (JP) 2024-177380

(51) Int. Cl. G03G 15/02; G03G 15/00; G03G 21/00

(52) U.S. Cl. CPC G03G 15/0225; G03G 15/0283; G03G 15/80; G03G 21/0064

(57) ABSTRACT

A process unit includes a rotatable image bearing member, a charging roller configured to come in contact with a surface of the image bearing member and configured to charge the surface, and a brush unit including (i) a brush including (i-1) a plate-shaped brush substrate and (i-2) brush bristles protruding from the brush substrate and configured to come into contact with a surface of the charging roller, (ii) a holding member configured to hold the brush substrate and regulate a position of the brush substrate, and (iii) a conduction member constituting at least part of a conduction path for applying a voltage to the brush, wherein the conduction member includes a contacting portion configured to contact the brush substrate, and is configured such that a direction in which the contacting portion applies a force to the brush substrate intersects with a thickness direction of the brush substrate.

### BACKGROUND

### Field of the Technology

The present disclosure relates to a process unit used for an image forming apparatus and to an image forming apparatus that forms an image on a recording material.

### Description of the Related Art

Japanese Patent Application Laid-Open No. 2019-32412 discloses that a brush-type cleaning member is disposed in an image forming apparatus of a cleanerless type to remove toner attached to a charging roller.

### SUMMARY

The present disclosure provides a new technique related to a process unit and an image forming apparatus in which a brush coming in contact a charging roller is provided.

An aspect of the present disclosure provides a process unit including a rotatable image bearing member, a charging roller configured to come in contact with a surface of the image bearing member and configured to charge the surface, and a brush unit including (i) a brush including (i-1) a plate-shaped brush substrate and (i-2) brush bristles protruding from the brush substrate and configured to come into contact with a surface of the charging roller, (ii) a holding member configured to hold the brush substrate and regulate a position of the brush substrate, and (iii) a conduction member constituting at least part of a conduction path for applying a voltage to the brush, wherein the conduction member includes a contacting portion configured to contact the brush substrate, and is configured such that a direction in which the contacting portion applies a force to the brush substrate intersects with a thickness direction of the brush substrate.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of part of a brush unit and a charging roller according to an embodiment.

FIG. 2A is a schematic view of an image forming apparatus according to the embodiment.

FIG. 2B is a perspective view of the image forming apparatus according to the embodiment.

FIG. 3 is a perspective view of the image forming apparatus according to the embodiment.

FIG. 4A is a section view of the process unit according to the embodiment.

FIG. 4B is a schematic diagram illustrating the layout of a photosensitive drum and a process member.

FIG. 5A is a perspective view of a drum unit according to the embodiment.

FIGS. 5B and 5C are each an enlarged view of part of the drum unit.

FIG. 6 is a perspective view of part of the drum unit according to the embodiment.

FIG. 7A is a rear view of the drum unit according to the embodiment.

FIGS. 7B and 7C are each a section view of the drum unit according to the embodiment.

FIGS. 7D to 7G are each a side view of the drum unit according to the embodiment.

FIGS. 8A and 8B are each a perspective view of a photosensitive drum and a charging roller according to the embodiment.

FIGS. 9A to 9E are each an explanatory diagram of a brush unit according to the embodiment.

FIGS. 10A and 10B are each an explanatory diagram of the brush unit according to the embodiment.

FIGS. 11A and 11B are each an explanatory diagram of the brush unit according to the embodiment.

FIG. 12A is a rear view of the drum unit according to the embodiment.

FIGS. 12B and 12C are each a section view of the drum unit according to the embodiment.

FIGS. 12D to 12G are each an enlarged view of part of the cross-section.

FIGS. 13A to 13C are each a perspective view of part of the brush unit according to the embodiment.

### DESCRIPTION OF THE EMBODIMENTS

An embodiment according to the present disclosure will be described below with reference to drawings.

### Image Forming Apparatus

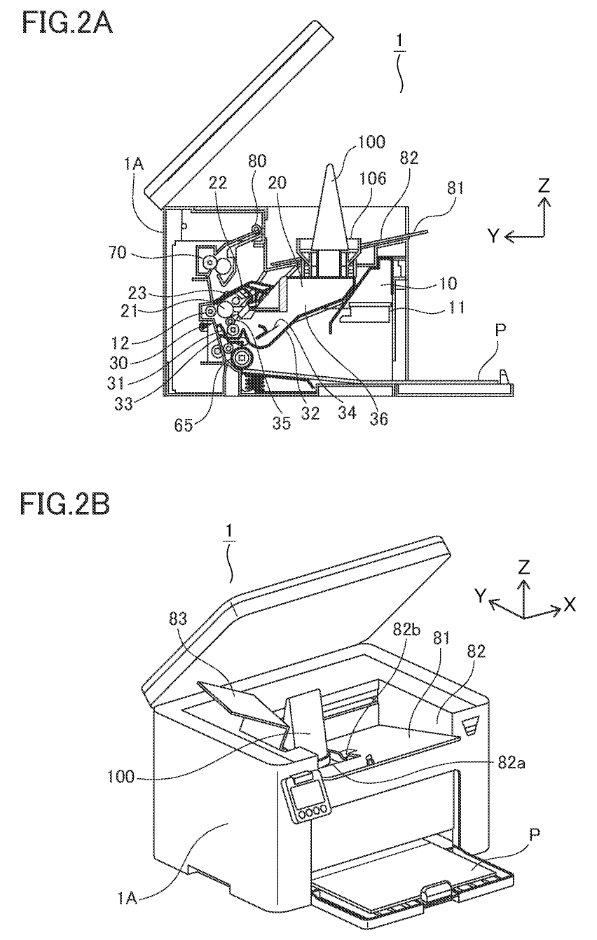

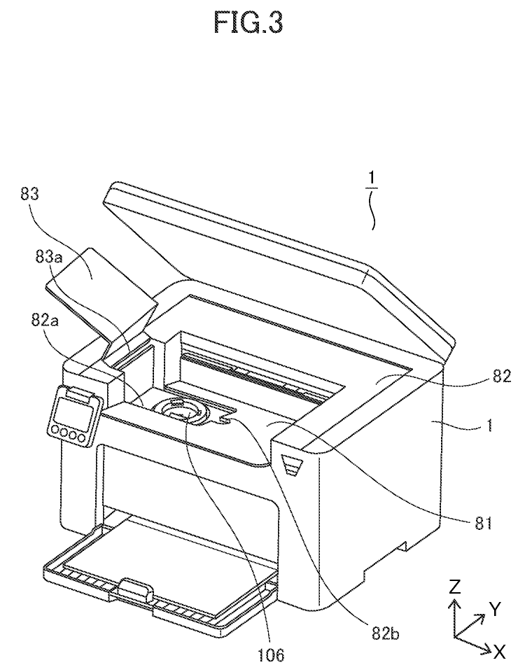

An image forming apparatus 1 according to an embodiment will be described with reference to FIGS. 2A, 2B, and 3. FIG. 2A is a schematic view of the image forming apparatus 1 according to the embodiment. FIGS. 2B and 3 are each a perspective view of the image forming apparatus 1.

An image forming apparatus generally refers to an apparatus that forms an image on a recording material P by an image forming portion of an electrophotographic system. Examples of the image forming apparatus include an electrophotographic copier, a laser beam printer, a light-emitting diode (LED) printer, and an electrophotographic facsimile machine. The image forming apparatus 1 of the present embodiment is a monochromatic laser beam printer that forms an image on the recording material P on the basis of image information input from an external device. Examples of the recording material P include various sheet materials of different materials. Examples of the various sheet materials include paper sheets such as plain paper sheets and cardboards, plastic films such as sheets for overhead projectors, sheets of irregular shapes such as envelopes and index paper sheets, and cloths.

The direction of the rotation axis of an image bearing member (photosensitive drum 21) included in the image forming apparatus 1 in the description and drawings below will be referred to as an X direction. The vertical direction (gravity direction) in the case where the image forming apparatus 1 is placed on a horizontal surface will be referred to as a Z direction. A direction intersecting with both the X direction and the Z direction will be referred to as a Y direction. The X direction, Y direction, and Z direction are preferably orthogonal to each other.

In the present embodiment, an input coupling portion 51a (described later) that receives the driving force of a drive source (motor) disposed in the apparatus body 1A is disposed on one end side of the process unit 20 in the X direction. Therefore, the one end side in the X direction (the side indicated by an arrow X in the drawing) may be referred to as the “drive side”, and the other side in the X direction (the side opposite to the side indicated by the arrow X) may be referred to as the “non-drive side”.

As illustrated in FIGS. 2A, 2B, and 3, the image forming apparatus 1 includes an apparatus body 1A, an image forming portion 10, a fixing portion 70, a pickup roller 65 serving as a feeding portion, and a discharge roller pair 80 serving as a discharge portion. The image forming portion 10 includes a process unit 20 serving as a process unit, a scanner unit 11 serving as an exposing unit, and a transfer roller 12 serving as a transfer unit.

The apparatus body 1A is a casing (structure body) including a frame member such as a metal plate frame constituting a frame member of the image forming apparatus 1, and a cover member constituting an exterior surface of the image forming apparatus 1. The image forming portion 10, the fixing portion 70, the pickup roller 65, and the discharge roller pair 80 are accommodated or supported by the apparatus body 1A.

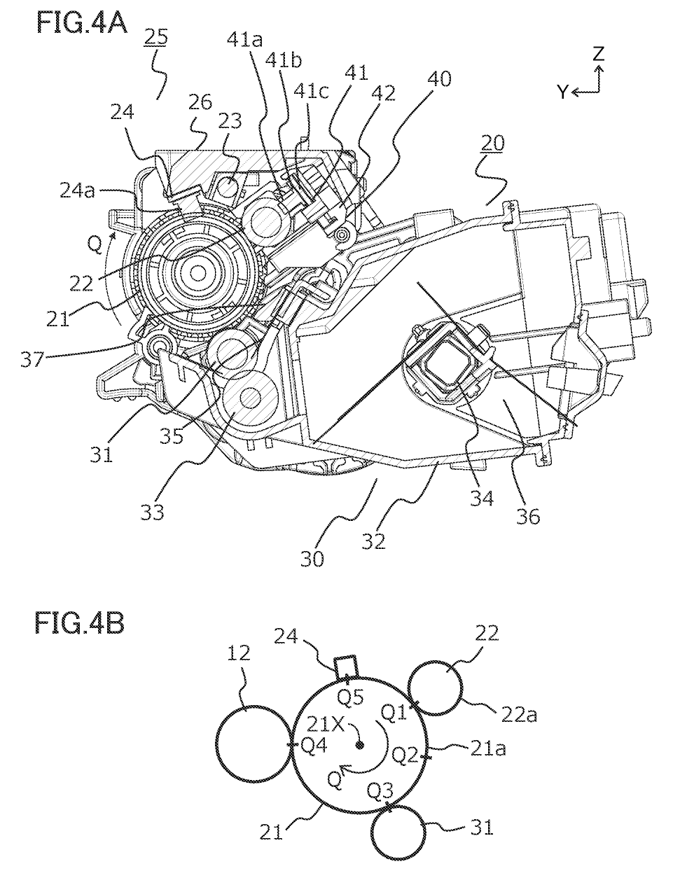

FIG. 4A is a section view of the process unit 20. FIG. 4B is a schematic view of the photosensitive drum 21 and process members disposed therearound. The process unit 20 of the present embodiment includes a drum unit 25 including a photosensitive drum 21, and a developing unit 30 including a developing roller 31.

The drum unit 25 includes the photosensitive drum 21, a charging roller 22, a pre-exposing portion 23, a paper dust collection brush 24 serving as a brush unit for the photosensitive drum 21, a brush unit 40 for the charging roller 22, and a drum frame member 26. The developing unit 30 includes the developing roller 31, a developing container 32, a supply roller 33, an agitation member 34, and a developing blade 35. In the case where the brush unit 40 for the charging roller 22 is a first brush unit, the brush unit for the photosensitive drum 21 can be referred to as a second brush unit.

The photosensitive drum 21 functions as an image bearing member that bears a latent image (electrostatic latent image) and a toner image (developer image). The photosensitive drum 21 is a photosensitive member formed in a cylindrical shape (drum shape). The photosensitive drum 21 of the present embodiment includes a columnar base body formed from aluminum, and a photosensitive layer formed from a negatively-chargeable organic photoconductor on the base body. The photosensitive drum 21 is rotationally driven at a predetermined peripheral speed (process speed) in a predetermined rotation direction (direction indicated by an arrow Q in FIGS. 4A and 4B) by the motor of the apparatus body 1A during image formation.

As illustrated in FIG. 4B, a position where a surface 21a of the photosensitive drum 21 and the charging roller 22 oppose each other will be referred to as a charging portion Q1. A position where the surface 21a of the photosensitive drum 21 is irradiated with laser light from the scanner unit 11 will be referred to as an exposing portion Q2. A position where the surface 21a of the photosensitive drum 21 and the developing roller 31 oppose each other will be referred to as a developing portion Q3. A position where the surface 21a of the photosensitive drum 21 and the transfer roller 12 oppose each other will be referred to as a transfer portion Q4. A position where the surface 21a of the photosensitive drum 21 and the paper dust collection brush 24 come into contact with each other will be referred to as a brush contact portion Q5. The charging portion Q1, the exposing portion Q2, the developing portion Q3, the transfer portion Q4, and the brush contact portion Q5 are arranged in this order in the rotation direction (Q) of the photosensitive drum 21 in image formation. That is, the rotation direction of the photosensitive drum 21 in image formation in the present embodiment is a rotation direction in which one point on the surface 21a of the photosensitive drum 21 passes through the charging portion Q1, the exposing portion Q2, the developing portion Q3, the transfer portion Q4, and the brush contact portion Q5 in this order.

The charging roller 22 is configured to come into contact with the photosensitive drum 21. The charging roller 22 of the present embodiment is capable of being in contact with and being separated from the photosensitive drum 21, and the image forming operation is performed in a state in which the charging roller 22 is in contact with the photosensitive drum 21. The charging roller 22 is rotatable in a direction in which the charging roller 22 follows the rotation of the photosensitive drum 21 (counterclockwise direction in FIG. 4A).

The charging roller 22 charges the surface 21a of the photosensitive drum 21 by receiving application of a charging voltage from a charging power source provided in the apparatus body 1A. The photosensitive drum 21 of the present embodiment is charged to a negative polarity by the charging roller 22.

The pre-exposing portion 23 is disposed at a position downstream of the brush contact portion Q5 and upstream of the charging portion Q1 in the rotation direction (Q) of the photosensitive drum 21. The pre-exposing portion 23 removes the surface charges of the photosensitive drum 21 by irradiating the surface 21a of the photosensitive drum 21 with light to cause a more stable electrical discharge at the charging portion.

The paper dust collection brush 24 (brush unit for the photosensitive drum 21) includes a brush portion 24a formed from a pile woven fabric or the like, and a support member that supports the brush portion 24a and is fixed to the drum frame member 26. The paper dust collection brush 24 blocks a foreign matter such as paper dust attached to the surface 21a of the photosensitive drum 21 at the brush contact portion Q5, and suppresses occurrence of an image defect caused by the foreign matter. Meanwhile, the paper dust collection brush 24 allows the toner attached to the surface 21a of the photosensitive drum 21 to pass through the brush contact portion Q5.

The brush unit 40 for the charging roller 22 includes a brush 41 capable of coming into contact with a surface 22a of the charging roller 22. The brush 41 can scrape off the foreign matter such as a paper dust or dust attached to the surface 22a of the charging roller 22. The detailed configuration and function of the brush unit 40 will be described later.

The scanner unit 11 exposes the photosensitive drum 21 by radiating laser light corresponding to image information input from an external device toward the photosensitive drum 21 and scanning the surface 21a of the photosensitive drum 21 by using a polygonal mirror (scanning optical system). As a result of this exposing step, an electrostatic latent image corresponding to the image information is formed on the surface 21a of the photosensitive drum 21. To be noted, the exposing unit is not limited to the scanner unit 11 that radiates laser light, and, for example, an LED exposing unit may be used. The LED exposing unit is an exposing unit that includes an LED array in which a plurality of LEDs are arranged in a rotation axis direction (main scanning direction in the exposing step) of the photosensitive drum 21 as a light source.

The developing unit 30 includes the developing roller 31 serving as a developer bearing member that bears developer, the developing container 32 serving as a frame member of the developing unit 30, the supply roller 33 capable of supplying developer to the developing roller 31, the agitation member 34, and the developing blade 35. The developing roller 31, the supply roller 33, and the agitation member 34 are rotatably supported by the developing container 32. In addition, the developing roller 31 is disposed at an opening portion of the developing container 32 so as to oppose the photosensitive drum 21. The supply roller 33 is rotatably in contact with the developing roller 31, and toner serving as developer stored in the developing container 32 is supplied to (applied on) the surface of the developing roller 31 by the supply roller 33. To be noted, the supply roller 33 is not necessarily needed as long as a configuration in which toner can be sufficiently supplied to the developing roller 31 is employed.

The developing unit 30 of the present embodiment employs a contact development system as a development system. That is, a toner layer borne on the developing roller 31 comes into contact with the surface 21a of the photosensitive drum 21 at the developing portion Q3 (developing region) where the photosensitive drum 21 and the developing roller 31 oppose each other. A developing voltage is applied to the developing roller 31 from a developing power source. The toner borne on the developing roller 31 transfers from the developing roller 31 to the surface 21a of the photosensitive drum 21 in accordance with the potential distribution of the surface 21a, and thus the electrostatic latent image is developed into a toner image. To be noted, in the present embodiment, a reversal development system is employed. That is, on the surface 21a of the photosensitive drum 21 charged in the charging step, the toner image is formed as a result of toner attaching to a region where the charge amount has been reduced by the light irradiation in the exposing step.

In addition, in the present embodiment, toner which has a particle diameter of about 6 μm and whose normal polarity (normal charging polarity) is a negative polarity is used. For example, a polymerized toner manufactured by a polymerization method is used as the toner of the present embodiment. In addition, the toner of the present embodiment does not contain a magnetic component, and is borne on the developing roller 31 mainly by an inter-molecular force or an electrostatic force (image force). To be noted, a one-component developer containing a magnetic component may be used. In addition, there is a case where the one-component developer contains additives (for example, wax and silica fine particles) for adjusting the fluidity and charging performance of the toner. In addition, a two-component developer constituted by a nonmagnetic toner and a magnetic carrier may be used as the developer. In the case of using a magnetic developer, for example, a cylindrical sleeve on the inner peripheral side of which a magnet is disposed is used as the developer bearing member (developing roller).

The developing container 32 functions as a toner storage portion that stores toner (developer). A toner storage chamber 36 that stores toner is formed inside the developing container 32. The agitation member 34 is disposed inside the toner storage chamber 36. The agitation member 34 rotates by being driven by the motor of the apparatus body 1A, thus agitates the toner in the developing container 32, and conveys the toner toward the developing roller 31 and the supply roller 33. In addition, the agitation member 34 circulates, in the developing container 32, the toner having passed the developing portion Q3 without being used for development and then peeled off from the developing roller 31, and thus uniformizes the toner in the developing container 32. To be noted, the agitation member 34 is not limited to a form that rotates. For example, the agitation member of a form that swings may be employed.

The developing blade 35 is disposed at the opening portion of the developing container 32 together with the developing roller 31. The developing blade 35 regulates the amount of toner borne on the developing roller 31. That is, the toner supplied to the surface of the developing roller 31 is regulated into a uniform thin layer by passing through the portion where the developing roller 31 opposes the developing blade 35 in accordance with the rotation of the developing roller 31. In addition, the charge amount of the toner supplied to the surface of the developing roller 31 is increased on the negative polarity side by frictional electrification when passing through an opposing portion between the developing roller 31 and the developing blade 35.

The developing unit 30 of the present embodiment includes a shielding member 37 disposed above the developing blade 35. The shielding member 37 shields the opposing portion between the developing roller 31 and the developing blade 35 and the opposing portion between the photosensitive drum 21 and the developing roller 31 such that foreign matter does not enter the opposing portions when the brush 41 scrapes off the foreign matter attached to the charging roller 22. The shielding member 37 is disposed at a position below the contact position between the brush 41 and the charging roller 22 and above the opposing portion between the developing roller 31 and the developing blade 35 and the opposing portion between the photosensitive drum 21 and the developing roller 31. The shielding member 37 is supported by the developing container 32, and extends from an upper surface portion of the developing container 32 to a position close to the surface 21a of the photosensitive drum 21. In the cross-section illustrated in FIG. 4A, the space between the drum unit 25 and the developing unit 30 and the space where the developing roller 31 is disposed are substantially segregated from each other by the shielding member 37 except for a minute gap between the shielding member 37 and the surface 21a of the photosensitive drum 21. The shielding member 37 may be a member fixed to the developing container 32 by a screw, an adhesive, or the like, or may be integrally formed with a resin member constituting the developing container 32.

The “process unit” is not limited to one including all the constituents of the process unit 20 of the present embodiment, and it suffices as long as the process unit includes an image bearing member (photosensitive drum) and at least one process member. The process member is a member that acts on the image bearing member to execute steps such as charging, exposure, development, transfer, and cleaning in an electrophotographic process. For example, the drum unit 25 in the case where the developing unit 30 is configured to be attachable to and detachable from the drum unit 25 including the photosensitive drum 21 and the charging roller 22 is an example of a process unit. The charging roller 22, the developing roller 31, and the brush unit (paper dust collection brush 24) for the photosensitive drum 21 in the present embodiment are examples of the process member.

### Image Forming Operation

Next, the image forming operation of the image forming apparatus 1 will be described. The image forming operation is a series of operation in which the image forming apparatus 1 forms an image on recording materials P by using the process unit 20 while conveying the recording materials P one by one. A controller of the image forming apparatus 1 starts the image forming operation when image information and an execution command of the image forming operation are received from an external device connected to the image forming apparatus 1.

When the image forming operation is started, in the image forming portion 10, the photosensitive drum 21 is rotationally driven, and the surface 21a of the photosensitive drum 21 is uniformly charged to a predetermined polarity and a predetermined potential at the charging portion Q1 by application of voltage to the charging roller 22. The scanner unit 11 radiates laser light toward the photosensitive drum 21 on the basis of the input image information. As a result of this, the surface 21a of the photosensitive drum 21 subjected to the charging process is exposed at the exposing portion Q2, and an electrostatic latent image is formed on the surface 21a of the photosensitive drum 21. The developing roller 31 rotates while bearing toner serving as a developer, and thus supplies the toner to the photosensitive drum 21 at the developing portion Q3. As a result of this, the electrostatic latent image is developed into a toner image (developer image).

In parallel with the operation of the image forming portion 10, the recording materials P are fed one by one by the pickup roller 65 from a recording material storage portion (tray, cassette) provided in a lower portion of the apparatus body 1A. The feeding timing of the recording material P is controlled such that the recording material P enters the transfer portion Q4 at a timing when the toner image formed on the photosensitive drum 21 reaches the transfer portion Q4. Then, when the recording material P passes through the transfer portion Q4, the toner image is transferred from the photosensitive drum 21 to the recording material P by the application of voltage to the transfer roller 12.

The recording material P having passed through the transfer portion Q4 is conveyed to the fixing portion 70 and subjected to an image fixation process. That is, the fixing portion 70 heats and pressurizes the toner image on the recording material P while nipping and conveying the recording material P in a nip portion of a rotary member pair such as a fixing roller pair. The recording material P having passed through the fixing portion 70 is discharged to the outside of the apparatus body 1A by the discharge roller pair 80, and is stacked on a discharge tray 81 serving as a stacking portion formed in an upper portion of the apparatus body 1A.

Here, the image forming apparatus 1 of the present embodiment does not include a cleaning member that collects (removes) toner (transfer residual toner) not transferred onto the recording material P (transfer target) at the transfer portion Q4 from the photosensitive drum 21. In the present embodiment, the transfer residual toner attached to the surface region on the photosensitive drum 21 having passed through the transfer portion Q4 passes through the brush contact portion Q5 and the charging portion Q1, and is then collected by the developing roller 31 at the developing portion Q3. Such a system is referred to as a cleanerless system or a simultaneous-development-and-cleaning system.

More specifically, at the brush contact portion Q5, the paper dust collection brush 24 blocks a foreign matter such as a paper dust attached from the recording material P to the photosensitive drum 21 but allows passage of the transfer residual toner. In addition, when the transfer residual toner passes through the charging portion Q1, charges of the normal polarity are supplied to toner particles charged to a polarity opposite to the normal polarity and toner particles whose charge amount is close to zero, and thus the charge amount of the transfer residual toner increases.

The behavior of the transfer residual toner passing through the developing portion Q3 after this differs depending on the region on the surface 21a of the photosensitive drum 21. Since the reversal development system is employed in the present embodiment, the surface potential (light potential) of the photosensitive drum 21 in the region (light region) exposed at the exposing portion Q2 is on the non-normal polarity side with respect to the potential of the developing roller 31 to which the developing voltage is applied. Therefore, the transfer residual toner attached to the light region stays on the surface 21a of the photosensitive drum 21 without transferring to the developing roller 31 at the developing portion Q3, and makes up part of the toner image together with the toner supplied from the developing roller 31. In contrast, the surface potential (dark potential) of the photosensitive drum 21 in the region (dark region) not exposed at the exposing portion Q2 is on the normal polarity side with respect to the potential of the developing roller 31 to which the developing voltage is applied. Therefore, the transfer residual toner attached to the dark region transfers to the developing roller 31 at the developing portion Q3, and is collected into the developing container 32. The transfer residual toner collected into the developing container 32 is agitated with toner present in the developing container 32, and is used for development again in a uniformized state.

In the cleanerless system, the foreign matter attached to the photosensitive drum 21 is not removed by a cleaning member in the transfer portion Q4. Even if the foreign matter is blocked by the paper dust collection brush 24 as in the present embodiment, part of the foreign matter can manage to pass through the paper dust collection brush 24. Therefore, as will be described below, it is preferable that occurrence of an image defect caused by the attachment of the foreign matter to the charging roller 22 is reduced by using the brush unit 40 for the charging roller 22.

### Toner Replenishment and Cartridge Replacement

Toner replenishment and cartridge replacement in the image forming apparatus 1 of the present embodiment will be described. As illustrated in FIGS. 2B and 3, a top cover 82 that is openable and closable is provided on an upper portion of the apparatus body 1A. At least part of the upper surface of the top cover 82 is formed as the discharge tray 81 serving as a stacking portion. An opening/closing member 83 openably and closably supported about a pivot shaft 83a extending in the front-rear direction (Y direction) of the apparatus is attached to the top cover 82. In addition, an opening portion 82a opening upward is formed in the discharge tray 81 of the top cover 82.

As illustrated in FIGS. 2A and 3, an attachment portion 106 to which a toner pack 100 serving as a replenishment container is attachable is provided in the image forming apparatus 1. The attachment portion 106 has an opening (toner inlet port) capable of communicating with a toner discharge port of the toner pack 100 and includes a shutter capable of opening and closing the toner inlet port. The attachment portion 106 may be part of the process unit 20, or may be fixed to the apparatus body 1A.

The opening/closing member 83 is configured to be movable between a closed position and an open position. The opening/closing member 83 closes the opening portion 82a at the closed position such that the toner pack 100 is not attached to the attachment portion 106, and opens the opening portion 82a at the open position such that attachment of the toner pack 100 to the attachment portion 106 is allowed. In the case where the opening/closing member 83 is at the open position, the attachment portion 106 is exposed to the outside of the image forming apparatus 1 through the opening portion 82a. The opening/closing member 83 functions as part of the discharge tray 81, and can support the recording material P discharged onto the discharge tray 81. In addition, as a result of a groove portion 82b provided in the top cover 82, a user can easily hook their fingers on the opening/closing member 83.

To be noted, in the present embodiment, a direct replenishment system is employed, in which the developing unit 30 in the image forming apparatus 1 can be replenished with toner from the outside of the image forming apparatus 1. That is, the user can replenish the developing unit 30 with toner from the toner pack 100 attached to the attachment portion 106 in a state in which the process unit 20 including the developing unit 30 is attached to the apparatus body 1A. In the state in which the toner pack 100 is attached to the attachment portion 106 of the image forming apparatus 1, at least part of the toner pack 100 is exposed to the outside of the image forming apparatus 1.

The direct replenishment system has the following advantages as compared with a system (process cartridge system) in which the whole process unit 20 is replaced. First, in the case where the toner remainder amount of the process unit 20 is small, the work of taking out the process unit 20 from the image forming apparatus 1 to replace the process unit 20 by a brand-new process cartridge is not needed, and therefore the usability can be improved. In addition, the developing container 32 can be replenished with toner at a lower cost than in the case of replacing the whole process unit 20. In addition, in the direct replenishment system, since various rollers and gears do not need to be replaced, the cost can be reduced as compared with a system (developing cartridge system) in which only the developing unit 30 in the process unit 20 is replaced.

The process unit 20 in the present embodiment is configured as a process cartridge attachable to and detachable from (capable of being attached to and separated from) the apparatus body 1A. The user can detach the process unit 20 from the apparatus body 1A and replace the process unit 20 by a brand-new process unit 20 by opening the opening/closing member provided on the apparatus body 1A.

To be noted, the configuration of the brush unit 40 described below may be applied to an image forming apparatus of a process cartridge system or a developing cartridge system. In addition, the process unit 20 is not limited to a cartridge attachable to and detachable from the apparatus body 1A, and may be, for example, fixed to the apparatus body 1A in a form not considering replacement by the user. That is, the “process unit” in the present disclosure may be one usable until the image forming apparatus 1 is expired without being replaced after being shipped in the state of being attached to the apparatus body 1A when the image forming apparatus 1 is manufactured.

### Drum Unit

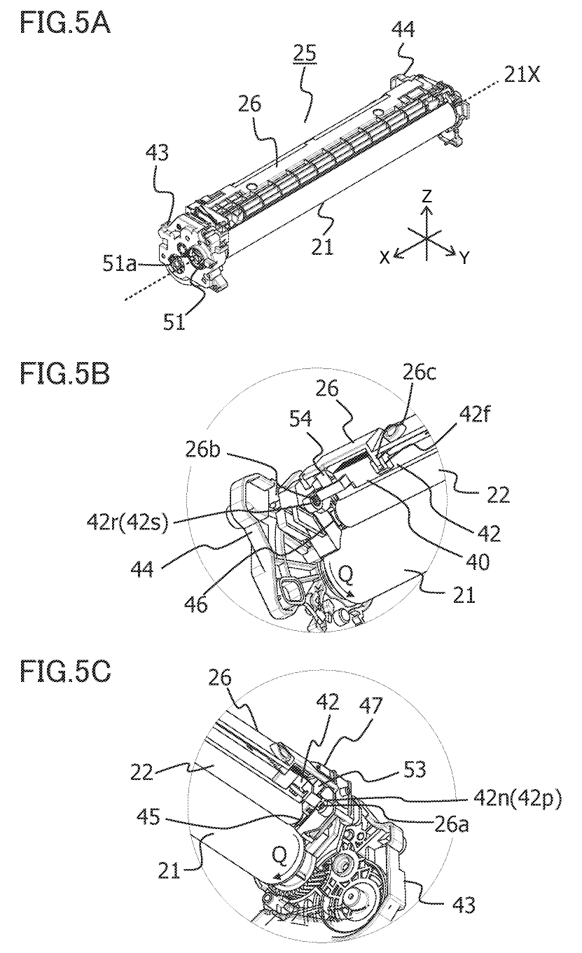

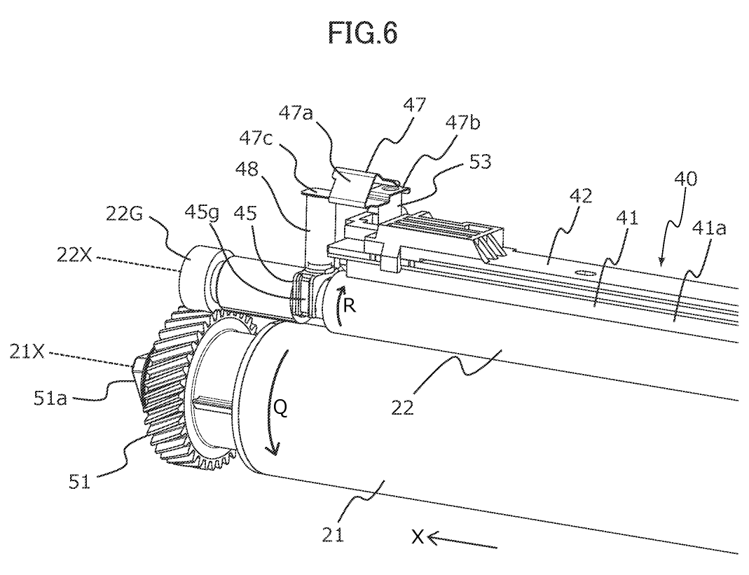

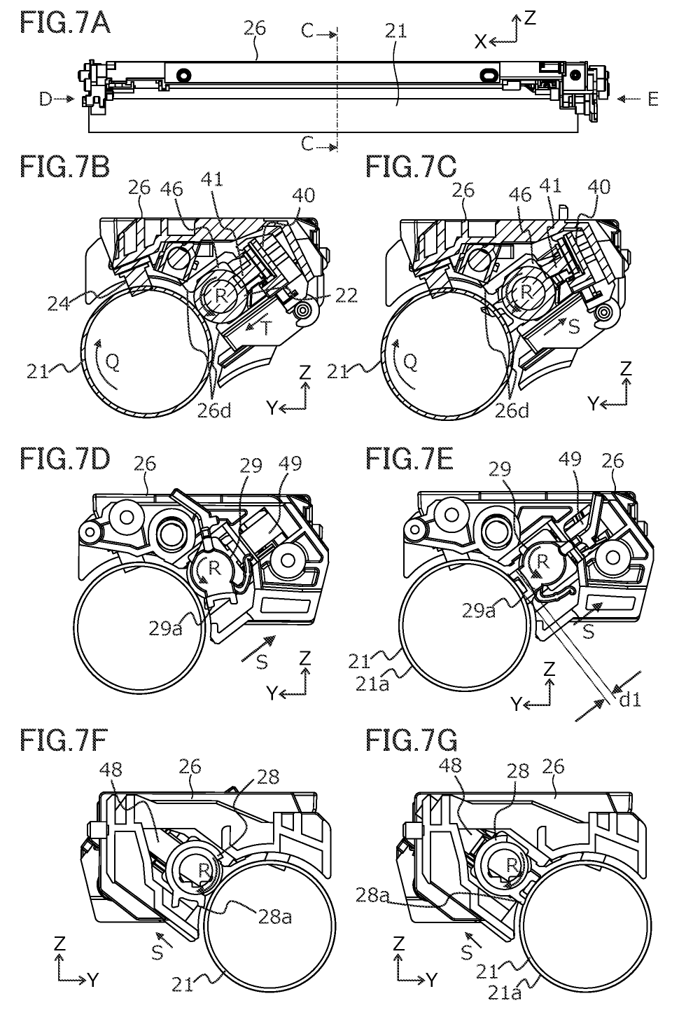

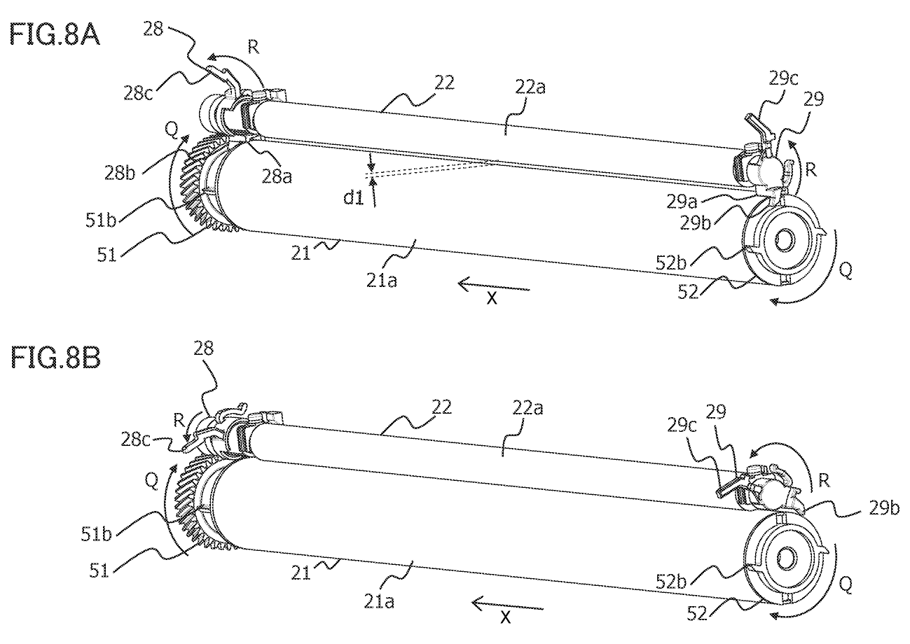

The configuration of the drum unit 25 will be described with reference to FIGS. 4A to 8B. FIG. 5A is a perspective view of the drum unit 25. FIG. 5B is a perspective view of an end portion of the drum unit 25 on the non-drive side as viewed from the center side of the drum unit 25 in the longitudinal direction. In addition, FIG. 5C is a perspective view of the drive-side end portion of the drum unit 25 as viewed from the center side of the drum unit 25 in the longitudinal direction. FIG. 6 is a perspective view of the drum unit 25 (excluding the drum frame member 26, a drive-side cover member 43, and a non-drive-side cover member 44). FIG. 7A is a diagram (rear view) illustrating the drum unit 25 (excluding the drum frame member 26, the drive-side cover member 43, and the non-drive-side cover member 44) as viewed from the upstream side in the Y direction. FIGS. 7B and 7C are each a section view of the drum unit 25 taken along a line C-C of FIG. 7A. FIGS. 7D and 7E are each a side view of the drum unit 25 as viewed in an arrow D direction of FIG. 7A. FIGS. 7F and 7G are each a side view of the drum unit 25 as viewed in an arrow E direction of FIG. 7A. FIGS. 8A and 8B are each a schematic diagram for describing contact and separation between the photosensitive drum 21 and the charging roller 22. FIGS. 7B, 7D, 7F, and 8B, each illustrate a state in which the charging roller 22 is in contact with the photosensitive drum 21, and FIGS. 7C, 7E, 7G, and 8A, each illustrate a state in which the charging roller 22 is separated from the photosensitive drum 21.

As illustrated in FIGS. 4A and 5A, the drum unit 25 includes the photosensitive drum 21, the charging roller 22, the paper dust collection brush 24, the drum frame member 26, the drive-side cover member 43, the non-drive-side cover member 44, and the brush unit 40. In addition, the drum unit 25 includes a drive-side shaft receiver 45 and a non-drive-side shaft receiver 46 (FIGS. 5B and 5C), charging roller urging members 48 and 49 (FIGS. 7D and 7F), charging roller separation members 28 and 29 (FIGS. 7D to 7G), and a charging roller electrical contact 47 (FIG. 6).

The drum unit 25 has a thin elongated shape extending in the rotation axis direction of the photosensitive drum 21. In addition, the charging roller 22 has a thin elongated shape extending in the rotation axis direction of the photosensitive drum 21. Therefore, in the description below, a direction (X direction) parallel to a rotation axis 21X of the photosensitive drum 21 may be referred to as a longitudinal direction of the drum unit 25, a longitudinal direction of the photosensitive drum 21, or a longitudinal direction of the charging roller 22 in some cases.

As illustrated in FIGS. 5A to 5C, the drive-side cover member 43 is attached to one end side (drive side) of the drum frame member 26 extending in the X direction, and the non-drive-side cover member 44 is attached to the other end side (non-drive side) of the drum frame member 26. The drive-side cover member 43 and the non-drive-side cover member 44 are fixed to the drum frame member 26 by a method such as screwing or gluing. The drive-side cover member 43 constitutes at least part of an end surface of the drum unit 25 on the one end side (drive side), and the non-drive-side cover member 44 constitutes at least part an end surface of the drum unit 25 on the other end side (non-drive side). The drum frame member 26, the drive-side cover member 43 and the non-drive-side cover member 44 coupled together constitute a frame member of the drum unit 25. In addition, the drum frame member 26, the drive-side cover member 43 and the non-drive-side cover member 44 coupled together constitute a frame member of the process unit 20 together with the frame member of the developing unit 30.

The photosensitive drum 21 is rotatably supported about the rotation axis 21X (FIG. 5A) by the drive-side cover member 43 and the non-drive-side cover member 44.

As illustrated in FIGS. 5A and 6, a drum driving member 51 is provided on one end side (drive side) of the photosensitive drum 21 in the longitudinal direction. The drum driving member 51 of the present embodiment integrally rotates with the outer peripheral portion of the photosensitive drum 21 that comes into contact with the charging roller 22. The drum driving member 51 includes an input coupling portion 51a serving as a drive input portion that receives a driving force (rotational force) for rotating the photosensitive drum 21 from the apparatus body 1A.

In a state in which the process unit 20 is attached to the apparatus body 1A, the input coupling portion 51a of the drum driving member 51 engages with the output coupling portion of the apparatus body 1A. A driving force is transmitted from the motor of the apparatus body 1A to the photosensitive drum 21 via the engagement between the output coupling portion and the input coupling portion 51a, and thus the photosensitive drum 21 is rotationally driven in a predetermined rotation direction (Q).

The charging roller 22 is rotatably supported by the drive-side shaft receiver 45 and the non-drive-side shaft receiver 46 serving as shaft-supporting members. To be noted, in the case where the drive-side shaft receiver 45 is a first shaft-supporting member, the non-drive-side shaft receiver 46 can be referred to as a second shaft-supporting member. The charging roller 22 rotates about a rotation axis 22X (FIG. 6) substantially parallel to the rotation axis 21X of the photosensitive drum 21.

The drive-side shaft receiver 45 and the non-drive-side shaft receiver 46 are supported by the drum frame member 26 in a form movable with respect to the drum frame member 26 in a direction intersecting with the longitudinal direction of the photosensitive drum 21. The charging roller 22 is movable in a direction (arrows S and T of FIGS. 7B and 7C) to move closer to and away from the photosensitive drum 21 in accordance with the movement of the drive-side shaft receiver 45 and the non-drive-side shaft receiver 46.

Specifically, the drive-side shaft receiver 45 and the non-drive-side shaft receiver 46 of the present embodiment are disposed to be sandwiched between two guides 26d (FIGS. 7B and 7C) provided in the drum frame member 26. Although the two guides 26d corresponding to the non-drive side shaft receiver 46 are illustrated in FIGS. 7B and 7C, two guides corresponding to the drive-side shaft receiver 45 are provided in the drum frame member 26. Groove portions 45g (FIG. 6) that engage with the guides 26d are formed in the drive-side shaft receiver 45 and the non-drive-side shaft receiver 46. The two guides 26d extend in a direction (arrows S and T) orthogonal to the longitudinal direction of the photosensitive drum 21. The drive-side shaft receiver 45 and the non-drive-side shaft receiver 46 are movable in an extending direction of the two guides 26d.

The charging roller urging members 48 and 49 are disposed on the respective end sides of the charging roller 22 in the longitudinal direction. The charging roller urging member 48 on the drive side is disposed between the drive-side shaft receiver 45 and the drum frame member 26 (FIGS. 7F and 7G). The charging roller urging member 49 on the non-drive side is disposed between the non-drive-side shaft receiver 46 and the drum frame member 26 (FIGS. 7D and 7E). The charging roller urging members 48 and 49 urge the drive-side shaft receiver 45 and the non-drive side shaft receiver 46 in such a direction (arrow T of FIG. 7B) that the charging roller 22 moves closer to the photosensitive drum 21.

As illustrated in FIG. 6, a drive input gear 22G is attached to an end portion of the charging roller 22 on the drive side. The drive input gear 22G is engaged with a gear portion of the drum driving member 51 described above. Therefore, the charging roller 22 of the present embodiment is rotated in a direction (arrow R in FIGS. 6 and 7B to 7G) to follow the rotation of the photosensitive drum 21 by a driving force transmitted thereto via the drum driving member 51 and the drive input gear 22G when the photosensitive drum 21 is rotationally driven.

To be noted, the charging roller 22 is not limited to a configuration to be rotated by drive transmission via the drum driving member 51 and the drive input gear 22G, and may be configured to be rotated by, for example, a frictional force acting between the surfaces 21a and 22a of the photosensitive drum 21 and the charging roller 22.

As illustrated in FIG. 4A, the paper dust collection brush 24 is fixed to the drum frame member 26 to come into contact with the photosensitive drum 21.

### Separation of Charging Roller

The configuration related to contact and separation of the charging roller 22 to and from the photosensitive drum 21 will be described. The image forming apparatus 1 of the present embodiment includes a mechanism capable of keeping the charging roller 22 out of contact from the photosensitive drum 21 in a period after the image forming apparatus 1 is shipped and before the image forming apparatus 1 reaches the user.

Specifically, as illustrated in FIG. 8A, the charging roller separation members 28 and 29 are provided at respective ends of the charging roller 22 in the longitudinal direction. The one charging roller separation member 28 is disposed on an end portion of the charging roller 22 on the drive side, and the other charging roller separation member 29 is disposed on an end portion of the charging roller 22 on the non-drive side. The charging roller separation members 28 and 29 are capable of rotating about the rotation axis 22X of the charging roller 22 and relatively rotating with respect to the charging roller 22.

As illustrated in FIGS. 8A and 8B, the charging roller separation members 28 and 29 respectively include abutment ribs 28a and 29a, force-receiving protrusion portions 28b and 29b, and levers 28c and 29c.

The abutment ribs 28a and 29a are formed to protrude more outward than the outer circumference of the charging roller 22. The abutment ribs 28a and 29a are capable of abutting the surface 21a of the photosensitive drum 21 on the outside of a region where the surface 22a of the charging roller 22 comes into contact with the surface 21a of the photosensitive drum 21 in the longitudinal direction (X direction) of the charging roller 22. As illustrated in FIGS. 8A, 7C, 7E, and 7G, in the case where the abutment ribs 28a and 29a abut the surface 21a of the photosensitive drum 21, a predetermined gap d1 is formed between the surface 22a of the charging roller 22 and the surface 21a of the photosensitive drum 21. In addition, the charging roller separation members 28 and 29 receive the urging force of the charging roller urging members 48 and 49. That is, as a result of the abutment ribs 28a and 29a abutting the surface 21a of the photosensitive drum 21, the charging roller 22 is held at a position (separation position) separated from the photosensitive drum 21 against the urging force of the charging roller urging members 48 and 49.

As illustrated in FIGS. 8A and 8B, the force-receiving protrusion portions 28b and 29b are disposed on respective end portions of the photosensitive drum 21 in the longitudinal direction. A protrusion portion 51b capable of engaging with the force-receiving protrusion portion 28b of the charging roller separation member 28 on the drive side is formed on the drum driving member 51 disposed on the one end side of the photosensitive drum 21. A drum flange 52 that integrally rotates with the photosensitive drum 21 is disposed on the other end side of the photosensitive drum 21. A protrusion portion 52b capable of engaging with the force-receiving protrusion portion 29b of the charging roller separation member 29 on the non-drive side is formed on the drum flange 52.

The force-receiving protrusion portion 28b of the charging roller separation member 28 and the protrusion portion 51b of the drum driving member 51 are disposed at the same position in the longitudinal direction (X direction) of the charging roller 22. The force-receiving protrusion portion 29b of the charging roller separation member 29 and the protrusion portion 52b of the drum flange 52 are disposed at the same position in the longitudinal direction (X direction) of the charging roller 22. In addition, the drum driving member 51 and the drum flange 52 of the present embodiment include a plurality of (specifically, four) pairs of protrusion portions 51b and 52b, each pair including one protrusion portion 51b and one protrusion portion 52b having the same rotational phase about the rotation axis 21X of the photosensitive drum 21.

After the image forming apparatus 1 is installed in a place where the user uses the image forming apparatus 1, the operation of bringing the charging roller 22 in contact with the photosensitive drum 21 is performed in the course of an initialization operation of the image forming apparatus 1. Specifically, in the course of the initialization operation, the photosensitive drum 21 is rotationally driven in the predetermined rotation direction (Q) by the driving force from the motor of the apparatus body 1A. As illustrated in FIG. 8B, one pair of the protrusion portions 51b and 52b of the drum driving member 51 and the drum flange 52 that integrally rotate with the photosensitive drum 21 abut and press the force-receiving protrusion portion 28b or 29b of the charging roller separation member 28 or 29. As a result of this, the charging roller separation members 28 and 29 rotate in the direction indicated by the arrow R.

The abutment between the surface 21a of the photosensitive drum 21 and the abutment ribs 28a and 29a is cancelled by the rotation of the charging roller separation members 28 and 29. Then, as illustrated in FIGS. 7B, 7D, and 7F, the drive-side shaft receiver 45 and the non-drive-side shaft receiver 46 slide in a direction indicated by an arrow T by the urging force of the charging roller urging members 48 and 49, and the charging roller 22 moves to a position (contacting position) where the charging roller 22 is in contact with the photosensitive drum 21.

To be noted, in the case of coupling the charging roller separation members 28 and 29 to the drum unit 25, the charging roller separation members 28 and 29 are coupled at a predetermined phase (FIG. 8A) where the charging roller 22 is held at the separation position. However, in the case where the charging roller separation members 28 and 29 rotate from the predetermined phase for some reason, the operator can return the charging roller separation members 28 and 29 to the predetermined phase by gripping and operating the levers 28c and 29c of the charging roller separation members 28 and 29.

By the mechanism described above, the charging roller 22 can be separated from the photosensitive drum 21 in, for example, a period after the image forming apparatus 1 is shipped and before the image forming apparatus 1 reaches the user. Therefore, deformation of the charging roller 22 caused by a situation in which the charging roller 22 is pressed against the photosensitive drum 21 for a long period in a stopped state can be suppressed, and thus the risk of an image defect caused by the deformation of the charging roller 22 can be reduced. In addition, after the image forming apparatus 1 reaches the user, the waiting time for the user to start using the image forming apparatus 1 can be shortened by the configuration in which the charging roller 22 automatically comes into contact with the photosensitive drum 21 in accordance with the rotation of the photosensitive drum 21.

### Conduction Path of Charging Roller

A configuration related to the conduction path of the charging roller 22 in the drum unit 25 will be described. As illustrated in FIG. 6, a charging roller electrical contact 47 is disposed on the one end side (drive side) of the drum unit 25 in the longitudinal direction (X direction) of the charging roller 22 and electrically connected to the charging roller 22.

Specifically, the charging roller electrical contact 47 includes a first contact portion 47a capable of coming into contact with an electrical contact (body-side contact portion) of the apparatus body 1A and a second contact portion 47b that comes into contact with one end of the charging roller urging member 48 on the drive side. The charging roller urging member 48 is, for example, a compression coil spring formed from a metal wire, and has electrical conductivity. The other end of the charging roller urging member 48 is in contact with the drive-side shaft receiver 45. The drive-side shaft receiver 45 is formed from, for example, a resin material kneaded with a conductive material such as carbon, and has electrical conductivity. In addition, the drive-side shaft receiver 45 includes, for example, a conductive shaft portion (metal shaft) of the charging roller 22. Therefore, the charging roller electrical contact 47 of the present embodiment is electrically connected to the charging roller 22 via the charging roller urging member 48 and the drive-side shaft receiver 45.

In a state in which the process unit 20 is attached to the apparatus body 1A, the first contact portion 47a of the charging roller electrical contact 47 comes into contact with a body-side contact portion of the apparatus body 1A. The body-side contact portion is electrically connected to a charging power source on a high-voltage board disposed in the apparatus body 1A. Therefore, the charging power source can apply a charging voltage to the charging roller 22 via the body-side contact portion and a conduction path from the charging roller electrical contact 47 to the charging roller 22.

### Brush Unit

The brush unit 40 for the charging roller 22 will be described. The brush unit 40 includes a brush 41 (FIG. 4A) including brush bristles 41a, and is configured such that the brush bristles 41a come into contact with the surface 22a of the charging roller 22. The brush 41 can scrape off the foreign matter attached to the surface 22a of the charging roller 22 by the brush bristles 41a.

In the case where a foreign matter such as dust attaches to the charging roller 22, there is a case where a charging failure caused by the foreign matter occurs and thus an image defect such as a black dot occurs. Specifically, the following situation can occur.

While the image forming apparatus 1 is used, there is a case where a foreign matter such as dust attaches to the surface 22a of the charging roller 22. For example, in the case where the image forming apparatus 1 is used in an environment (outdoors or an environment close thereto) in which the amount of dust floating in the air is large, dust is more likely to attach to the charging roller 22. The path of entrance for the foreign matter is not limited to one, and for example, a path through which the dust attaches from the recording material P to the photosensitive drum 21 in the transfer portion Q4 and then attaches from the photosensitive drum 21 to the charging roller 22 and a path through which the dust is taken into the apparatus body 1A together with the outside air and reaches the charging roller 22 on an airflow are expected.

When a foreign matter attaches to the surface 22a of the charging roller 22, an image defect caused by a charging failure can occur. For example, in the case where the charging roller 22 rotates in a state in which a foreign matter such as dust is attached to a certain position on the surface 22a of the charging roller 22, the foreign matter can be embedded in the surface 22a as a result of repeatedly passing through the charging portion Q1. In this case, a dot-shaped periodical image defect can occur at an interval corresponding to the peripheral length of the charging roller 22 in an image output by the image forming operation, as a result of the occurrence of the dot-shaped charging failure at the position corresponding to the foreign matter. Such an image defect is also referred to as black dots.

As a result of providing the brush unit 40 for the charging roller 22, the foreign matter attached to the surface 22a of the charging roller 22 can be scraped off by the brush bristles 41a of the brush 41. As a result of the brush 41, stagnation of the foreign matter such as dust at the same position on the surface 22a of the charging roller 22 can be suppressed, and thus the image defect such as black dots caused by the attachment of foreign matter can be made less likely to occur. Further, high image quality can be maintained for a long period even in the case where, for example, the image forming apparatus 1 is used in an environment in which the amount of dust floating in the air is large.

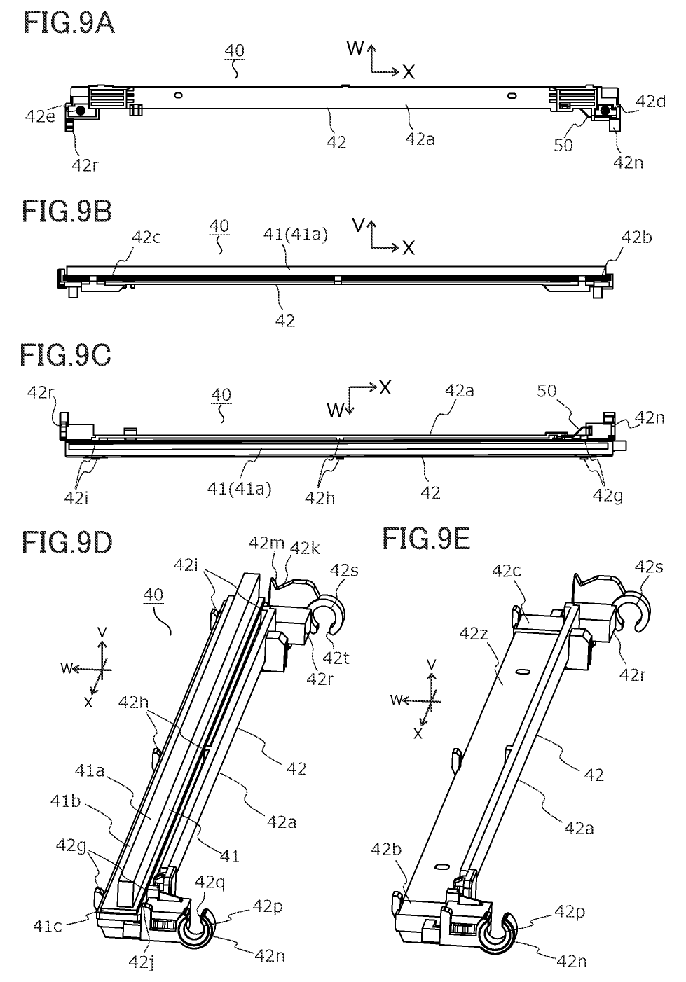

The details of the brush unit 40 will be described with reference to FIGS. 9A to 11. The brush 41 has a thin elongated shape extending in the longitudinal direction (X direction) of the charging roller 22. In the description below, the longitudinal direction (X direction) of the charging roller 22 may be referred to as the longitudinal direction of the brush 41. A direction (W direction in the drawing) that is orthogonal to the longitudinal direction (X direction) of the brush 41 and that extends along the brush substrate of the brush 41 may be referred to as the short-side direction of the brush 41. In addition, a direction (V direction in the drawings) orthogonal to both the longitudinal direction (X direction) and the short-side direction (W direction) of the brush 41 may be referred to as a height direction of the brush 41. The V direction and the W direction do not necessarily coincide with the Y direction and the Z direction described above.

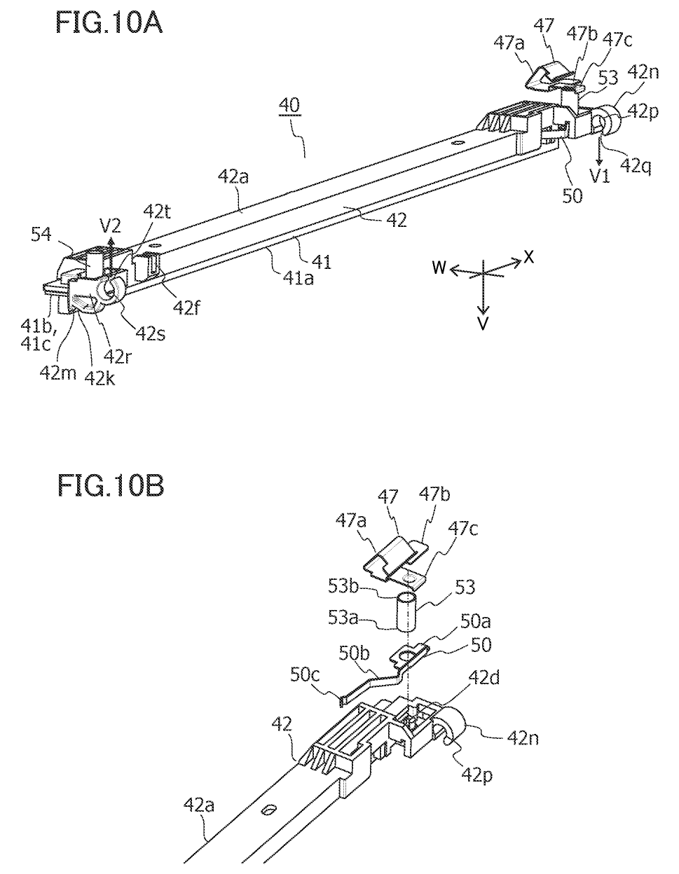

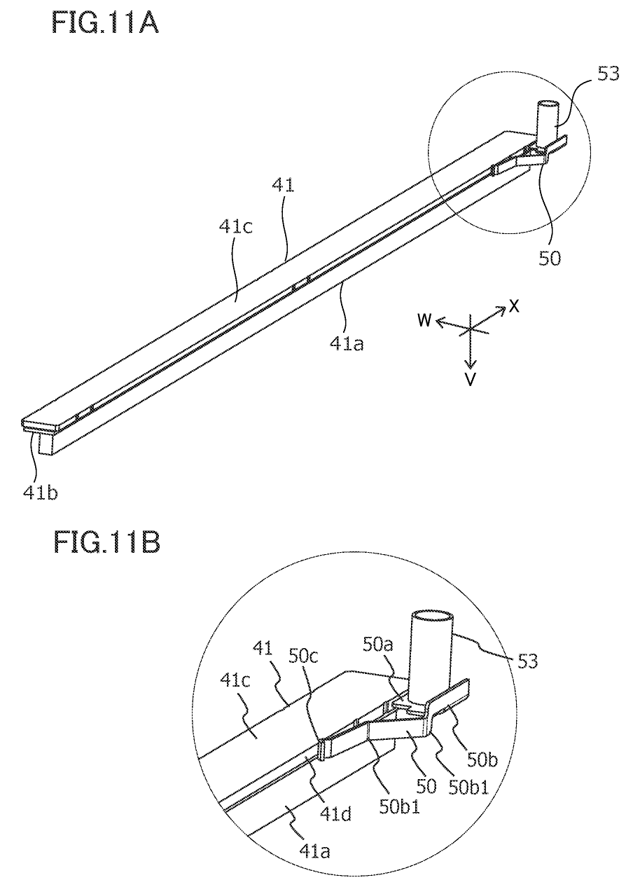

FIG. 9A is a diagram illustrating the brush unit 40 as viewed form the side opposite to the charging roller 22 in the height direction (V direction) of the brush 41. FIG. 9B is a diagram illustrating the short-side direction (W direction) of the brush unit 40. FIG. 9C illustrates the brush unit 40 as viewed from the charging roller 22 side in the height direction (V direction) of the brush 41. FIG. 9D is a perspective view of the brush unit 40. FIG. 9E is a perspective view of the brush base 42. FIG. 10A is a perspective view of the brush unit 40. FIG. 10B is an exploded view of an end portion of the brush unit 40 on the non-drive side. FIG. 11 is a perspective view of the brush 41 and a brush electrical contact 50.

As illustrated in FIGS. 9D and 10, the brush unit 40 includes the brush 41, the brush base 42, the brush electrical contact 50, and brush urging members 53 and 54.

The brush 41 includes the brush bristles 41a (brush hair), a sheet-shaped bristle-supporting portion 41b that supports the brush bristles 41a, and a plate-shaped backing member 41c that supports the bristle-supporting portion 41b. The bristle-supporting portion 41b and the backing member 41c constitute a plate-shaped brush substrate. The brush bristles 41a protrudes from the brush substrate toward one side in the thickness direction of the brush substrate (thickness direction of the backing member 41c).

The brush 41 of the present embodiment is formed by, for example, attaching a pile woven fabric to the backing member 41c by using an adhesive. The brush bristles 41a are, for example, a pile of conductive yarns formed from nylon fiber containing carbon as a conducting agent, and the bristle-supporting portion 41b is a ground fabric into which a pile of conductive yarns is woven. The backing member 41c is, for example, a metal plate member. In addition, it can be also said that the brush 41 of the present embodiment is constituted by a brush body including the brush bristles 41a and the bristle-supporting portion 41b and a support body (backing member 41c) that supports the brush body.

To be noted, the brush 41 is not limited to one that is formed by combining a pile woven fabric with a metal plate member. For example, the brush 41 may include a resin brush substrate having a plurality of holes and bundles of the brush bristles 41a planted in respective holes of the brush substrate. That is, the brush substrate of the brush 41 is not limited to one that is formed by combining the bristle-supporting portion 41b (portion that directly supports the brush bristles 41a) and the backing member 41c (portion that supports the bristle-supporting portion 41b), and may be an integrally-molded part that supports the brush bristles 41a.

The brush base 42 is an example of a holding member that holds the brush 41. The brush base 42 includes a main unit portion 42a serving as a brush holding portion that holds the brush 41, and swing support portions 42n and 42r serving as supported portions supported by the drum frame member 26. The main unit portion 42a of the present embodiment holds the brush substrate (particularly, the backing member 41c) of the brush 41. The swing support portions 42n and 42r integrally swing with the main unit portion 42a.

To be noted, although an example in which the main unit portion 42a and the swing support portions 42n and 42r are integrally formed is described in the present embodiment, the swing support portions 42n and 42r may be separate members from the main unit portion 42a, and may be fixed to the main unit portion 42a by screws, an adhesive, or the like. In addition, as shown in the example in which the swing support portions 42n and 42r that are separate members from the main unit portion 42a are fixed to the main unit portion 42a, the “holding member” does not have to be constituted by a single member.

The brush base 42 includes a drive-side position regulation portion 42j and non-drive-side position regulation portions 42k and 42m as regulation portions (abutted portions) for regulating the position of the brush unit 40. The drive-side shaft receiver 45 and the non-drive-side shaft receiver 46 respectively include abutment portions (45a, 46a, and 46b) that respectively abut the drive-side position regulation portion 42j and the non-drive-side regulation portions 42k and 42m. That is, the drive-side shaft receiver 45 and the non-drive-side shaft receiver 46 of the present embodiment function as regulation members (positioning members) that regulate the position of the brush base 42 by abutting the brush base 42 (holding member). In the case where the drive-side position regulation portion 42j is a first regulation portion, the non-drive-side position regulation portions 42k and 42m can be referred to as second regulation portions. The position regulation of the brush unit 40 will be described later.

The main unit portion 42a of the brush base 42 extends in the longitudinal direction (X direction) of the brush 41 approximately to the whole length of the region where the brush bristles 41a are disposed. The brush 41, the brush electrical contact 50, and the brush urging members 53 and 54 are disposed in the main unit portion 42a. The swing support portions 42n and 42r are disposed on the respective outer sides of the main unit portion 42a in the longitudinal direction (X direction) of the brush 41. One swing support portion 42n is disposed on the drive side, and the other swing support portion 42r is disposed on the non-drive side.

The brush base 42 is movably supported by the drum frame member 26 (FIGS. 5B, 5C, and 6), and is movable in a direction to move closer to and away from the charging roller 22. That is, the brush unit 40 is movable such that the brush base 42 (brush holding portion) moves closer to and away from the charging roller 22. The brush unit 40 of the present embodiment is swingable (rotatable) with respect to the drum frame member 26 as a result of support holes 42p and 42s provided in the brush base 42 being engaged with support shafts 26a and 26b provided in the drum frame member 26. In addition, the brush unit 40 of the present embodiment is urged by the brush urging members 53 and 54 in such a direction that the brush substrate (41b and 41c) of the brush 41 and the brush base 42 move closer to the charging roller 22.

The main unit portion 42a of the brush base 42 is provided with width regulation grooves 42g, 42h, and 42i for regulating the position of the brush 41 in the short-side direction (W direction) of the brush 41. In the brush base 42 of the present embodiment, the width regulation grooves 42g, 42h, and 42i are respectively provided at the drive-side end portion, center, and non-drive-side end portion of the main unit portion 42a in the longitudinal direction (X direction) of the brush 41. The number and arrangement of the width regulation grooves 42g, 42h, and 42i may be changed. The inner widths of the width regulation grooves 42g, 42h, and 42i are set to be approximately equal to the width of the brush 41 (particularly, the width of the backing member 41c) in the short-side direction (W direction) of the brush 41. As a result of the brush 41 engaging with the width regulation grooves 42g, 42h, and 42i, the position of the brush 41 in the short-side direction (W direction) with respect to the brush base 42 is regulated (determined).

In addition, in the present embodiment, the drum frame member 26 is provided with a longitudinal regulation rib 26c (FIG. 5B), and the main unit portion 42a of the brush base 42 is provided with a longitudinal regulation groove 42f (also see FIG. 10A). The longitudinal regulation rib 26c protrudes in a direction intersecting with the longitudinal direction (X direction) of the brush 41. As a result of the longitudinal regulation rib 26c engaging with the longitudinal regulation groove 42f, the position of the brush unit 40 with respect to the drum frame member 26 in the longitudinal direction (X direction) of the brush 41 is regulated (determined). To be noted, the brush base 42 may be provided with a longitudinal regulation rib (protrusion portion) protruding in a direction intersecting with the longitudinal direction (X direction), and the drum frame member 26 may be provided with a longitudinal regulation groove (recess portion) that engages with the longitudinal regulation rib.

As illustrated in FIG. 9E, brush placement surfaces 42b and 42c are provided at respective end portions of the main unit portion 42a in the longitudinal direction (X direction) of the brush 41. The brush placement surfaces 42b and 42c protrude toward the brush 41 in the height direction (V direction) of the brush 41 as compared with a surface 42z between the brush placement surfaces 42b and 42c. The backing member 41c is fixed to the brush placement surfaces 42b and 42c by a method such as gluing using an adhesive, and thus the brush 41 is fixed to the brush base 42. In a state in which the brush 41 is fixed to the brush placement surface 42b and 42c, the surface 42z between the brush placement surfaces 42b and 42c is mainly not in contact with the brush 41.

In other words, the main unit portion 42a (brush holding portion) includes an opposing surface (42b, 42c, and 42z) that opposes the backing member 41c (metal plate member) in the thickness direction of the brush substrate (41b and 41c) of the brush 41. The opposing surface includes the brush placement surface 42b (first placement surface portion) to which one end portion of the metal plate member in the rotation axis direction (X direction) of the charging roller is fixed and the brush placement surface 42c (second placement surface portion) to which the other end portion of the metal plate member in the rotation axis direction (X direction) of the charging roller is fixed. In addition, the opposing surface includes the surface 42z (non-fixed portion) that is formed in a region between the first placement surface portion and the second placement surface portion in the rotation axis direction (X direction) of the charging roller and to which the metal plate member is not fixed.

In the present embodiment, the brush base 42 is a molded product (resin molded component), and slight deformation can occur at the time of molding. For example, the brush base 42 can be warped such that the center portion of the brush base 42 in the longitudinal direction (X direction) protrudes toward the brush 41 or toward the opposite side thereto in the height direction (V direction). In addition, the brush base 42 can be twisted such that the directions of the brush placement surfaces 42b and 42c differ between the one end side and the other end side in the longitudinal direction (X direction).

Therefore, by employing a configuration in which the brush 41 includes the backing member 41c that is formed from metal and has a high stiffness and the respective end portions of the backing member 41c are fixed to the brush placement surfaces 42b and 42c of the brush base 42, the deformation of the brush base 42 can be corrected. That is, the warpage and twist of the brush base 42 can be corrected by following the backing member 41c having a higher stiffness than the brush base 42. As a result of this, a situation in which the shape error or the like of the brush base 42 affects the position and shape of the brush 41 can be suppressed, and thus the brush bristles 41a can be stably brought into contact with the charging roller 22.

As illustrated in FIGS. 9D and 10A, the swing support portions 42n and 42r (first extending portion and second extending portion) of the brush base 42 extend (protrude) toward one side in the short-side direction (W direction) of the brush 41 with respect to the main unit portion 42a. Support holes 42p and 42s serving as hole portions or receiving portions are respectively formed at distal ends of the swing support portions 42n and 42r. The drum frame member 26 is provided with support shafts 26a and 26b (FIGS. 5B and 5C) serving as shaft portions that engage with the hole portions (receiving portions). As a result of the support holes 42p and 42s respectively engaging with (receiving) the support shafts 26a and 26b of the drum frame member 26, the brush unit 40 is swingably supported with respect to the drum frame member 26. The support shafts 26a and 26b both extend in the rotation axis direction (longitudinal direction of the brush 41, X direction) of the charging roller 22. An imaginary straight line passing through the centers of the support shafts 26a and 26b is a swing axis of the brush unit 40.

In the case where the swing support portion 42n and the support shaft 26a on the drive side are respectively a first swing support portion and a first support portion, the swing support portion 42r and the support shaft 26b on the non-drive side can be respectively referred to as a second swing support portion and a second support portion. In addition, in the case where the support hole 42p and the support shaft 26a are respectively a first hole portion (first receiving portion) and a first shaft portion, the support hole 42s and the support shaft 26b can be respectively referred to as a second hole portion (second receiving portion) and a second shaft portion. To be noted, although the support shafts 26a and 26b (shaft portions) are disposed in the drum frame member 26 and the support holes 42s and 42p (hole portions, receiving portions) are formed in the brush unit 40 in the present embodiment, the hole portions (receiving portions) may be formed in the drum frame member 26, and the shaft portions that engage with the hole portions (receiving portions) may be disposed in the brush unit 40.

In addition, the swing support portions 42n and 42r are respectively provided with openings 42q and 42t where the support holes 42p and 42s open in a direction intersecting with the swing axis of the brush unit 40. In other words, as a result of providing the openings 42q and 42t, the support holes 42p and 42s are each formed as an arcuate shape where part of the circumference thereof about the swing axis of the brush unit 40 is cut out. An opening direction V1 of the opening 42q on the drive side and an opening direction V2 of the opening 42t on the non-drive side are different. As a result of providing the openings 42q and 42t, the support holes 42p and 42s can be more easily engaged with the support shafts 26a and 26b when attaching the brush unit 40 to the drum frame member 26.

As illustrated in FIGS. 10A and 10B, the brush urging members 53 and 54 are respectively attached to one end portion and the other end portion of the main unit portion 42a in the longitudinal direction (X direction) of the brush 41. Specifically, a first end 53a of the brush urging member 53 on the drive side is attached to the shaft portion 42d provided at the one end portion of the main unit portion 42a. One end of the brush urging member 54 on the non-drive side is attached to a shaft portion 42e (FIG. 9A) provided at the other end portion of the main unit portion 42a.

The brush electrical contact 50 includes a first portion 50a where a hole portion that engages with the shaft portion 42d is formed, and a second portion 50b extending in the longitudinal direction (X direction) of the brush 41 from the first portion 50a. The brush electrical contact 50 is formed by, for example, punching and bending one metal plate member.

The first portion 50a has a flat surface shape approximately orthogonal to the height direction (V direction) of the brush 41, and is supported in a state of being sandwiched between the first end 53a of the brush urging member 53 and the brush base 42 while the hole portion thereof is engaged with the shaft portion 42d. The other end (second end 53b) of the brush urging member 53 is in contact with a third contact portion 47c provided in the charging roller electrical contact 47 described above (also see FIG. 6).

As illustrated in FIGS. 11A and 11B, a contacting portion 50c that contacts a side surface 41d of the backing member 41c of the brush 41 in the short-side direction (W direction) is provided at a distal end of the second portion 50b of the brush electrical contact 50. The second portion 50b is provided with one or more bent portions 50b1 for reliably causing the contacting portion 50c to contact a side surface 41d of the backing member 41c by using elasticity (spring property) of a metal plate. The contacting portion 50c is in pressure contact with the side surface 41d of the backing member 41c by the elasticity (spring property) of the second portion 50b of the brush electrical contact 50.

According to the configuration described above, the brush 41 is electrically connected to a body-side contact portion of the apparatus body 1A via the charging roller electrical contact 47, the brush urging member 53, and the brush electrical contact 50. In addition, since the brush 41 is electrically connected to the charging roller 22 via the brush electrical contact 50, the potential of the brush 41 is equal to the charging roller 22. In other words, a charging voltage is applied from the charging power source of the apparatus body 1A to both the brush 41 and the charging roller 22 via the brush electrical contact 50.

The foreign matter attached to the charging roller 22 can be electrified. Therefore, in the case where there is a potential difference between the brush 41 and the charging roller 22, there is a case where the foreign matter passing through the contact portion between the charging roller 22 and the brush 41 is electrostatically pressed against to the charging roller 22, and thus it is difficult for the brush 41 to scrape off the foreign matter. In the case where the brush 41 and the charging roller 22 are at the same potential, the foreign matter attached to the surface 22a of the charging roller 22 can be easily scraped off by the brush 41 regardless of whether or not the foreign matter is electrified.

To be noted, if the charging roller 22 and the brush 41 are electrically connected, a similar advantage can be obtained regardless of the specific configuration of the conduction path. In the present embodiment, an example in which a conduction path from a charging roller electrical contact 47 that is a contact member exposed to the outside of the process unit 20 branches into a conduction path to the charging roller 22 and a conduction path to the brush 41 has been described. The configuration is not limited to this, and for example, the conduction path from the charging roller 22 to the brush 41 may be formed by disposing a conductive member such as a wire electrically interconnecting the drive-side shaft receiver 45 and the backing member 41c of the brush 41 in the swing support portion 42n and the main unit portion 42a. Alternatively, a similar conduction path may be formed by forming part of the swing support portion 42n and the main unit portion 42a from a conductive resin.

### Position Regulation of Brush Unit

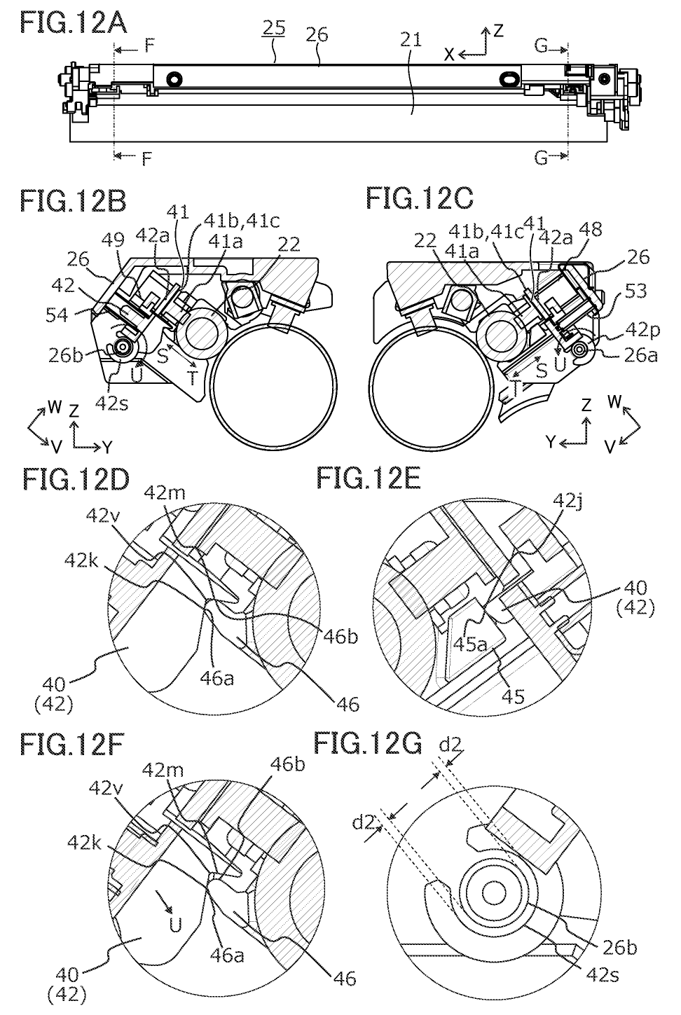

Position regulation of the brush unit 40 will be described with reference to FIGS. 12A to 12G. FIG. 12A is a diagram (rear view) illustrating the drum unit 25 as viewed from the upstream side in the Y direction. FIG. 12B is a section view of the drum unit 25 taken along a line G-G in FIG. 12A. FIG. 12C is a section view of the drum unit 25 taken along a line F-F of FIG. 12A. FIG. 12D is an enlarged view of part (part where the brush unit 40 abuts the non-drive-side shaft receiver 46) of FIG. 12B. FIG. 12E is an enlarged view of part (part where the brush unit 40 abuts the drive-side shaft receiver 45) of FIG. 12C. FIG. 12F is a diagram illustrating a state in which the brush unit 40 has rotated about the support shafts 26a and 26b from the state of FIG. 12D. FIG. 12G is an enlarged view of part (near the support shaft 26b) of FIG. 12B.

As described above, the brush unit 40 is movable with respect to the charging roller 22. The brush base 42 (holding member) is movable in such a movement direction that the brush substrate (41b and 41c) of the brush 41 moves closer to and away from the charging roller 22 (FIGS. 12B and 12C). The brush base 42 of the present embodiment is movable (swingable) with respect to the charging roller 22 with the rotation direction (arrow U) about the support shafts 26a and 26b as a movement direction, as a result of the support holes 42p and 42s respectively engaging with the support shafts 26a and 26b of the drum frame member 26.

Here, the “movement direction” of the brush base 42 may be a direction including a component in a direction orthogonal to the tangent of an arc centered on the rotation axis of the charging roller 22. For example, the “movement direction” may be a linear direction intersecting with an arc centered on the rotation axis of the charging roller 22, or a rotational direction about an axis parallel to and away from the rotation axis of the charging roller 22. In addition, the “movement direction” is not limited to a linear direction following a single straight line and a direction following a single arc, and may be a direction following a curved line that is a combination of a plurality of line segments and/or a plurality of curved portions. For example, in the case where the brush base 42 moves while being guided by a guide shape such as a groove portion provided in the drum frame member 26, the “movement direction” may be a direction following the guide shape.

The brush unit 40 of the present embodiment is urged by the brush urging members 53 and 54 in a direction indicated by an arrow U in the drawing in the rotational direction about the support shafts 26a and 26b. The position of the brush unit 40 in the rotational direction about the support shafts 26a and 26b is regulated (determined) by abutting the drive-side shaft receiver 45 and the non-drive-side shaft receiver 46.

The support hole 42p and the support shaft 26a on the one side (drive side) in the longitudinal direction (X direction) of the brush 41 are fit with each other so as to be smoothly slidable with respect to each other (FIG. 12B). In other words, the inner diameter of the support hole 42p is set to be approximately equal to the outer diameter of the support shaft 26a, and the inner surface of the support hole 42p (first hole portion) is slidably in contact with the outer surface of the support shaft 26a (first shaft portion). In contrast, in the case of the support hole 42s and the support shaft 26b on the other side (non-drive side), a gap d2 is formed between the outer surface of the support shaft 26b and the inner surface of the support hole 42s as illustrated in FIG. 12G. In other words, the inner diameter of the support hole 42s (second hole portion) is set to be larger than the outer diameter of the support shaft 26b (second shaft portion), and the difference between the inner diameter of the support hole 42s and the outer diameter of the support shaft 26b is larger than the difference between the inner diameter of the support hole 42p and the outer diameter of the support shaft 26a. The effect of the gap d2 will be described later.

The position regulation of the brush unit 40 will be described in further detail. On the one end side (drive side) of the brush unit 40 in the longitudinal direction (X direction) of the brush 41, a drive-side position regulation portion 42j provided in the main unit portion 42a of the brush base 42 abuts a drive-side abutment portion 45a of the drive-side shaft receiver 45 as illustrated in FIG. 12E. The drive-side shaft receiver 45 is movable with respect to the drum frame member 26 in such a direction (arrows S and T) that the charging roller 22 moves closer to and away from the photosensitive drum 21 as described above, but is positioned by the contact between the charging roller 22 and the photosensitive drum 21. Therefore, the swing of the brush base 42 in the arrow U direction caused by the urging force of the brush urging members 53 and 54 is stopped by the abutment between the drive-side position regulation portion 42j and the drive-side abutment portion 45a. Further, as described above, no gap is provided between the support hole 42s and the support shaft 26a. Therefore, on the drive side, the position of the brush unit 40 (position of the brush base 42) is determined on the basis of the center of the support shaft 26a and the abutment position (hitting position) between the drive-side position regulation portion 42j and the drive-side abutment portion 45a.

In contrast, on the other end side (non-drive side) of the brush unit 40, as shown in FIG. 12D, non-drive-side position regulation portions 42k and 42m provided in the main unit portion 42a of the brush base 42 abut non-drive side abutment portions 46a and 46b of the non-drive-side shaft receiver 46. The non-drive-side shaft receiver 46 is movable with respect to the drum frame member 26 in such a direction (arrows S and T) that the charging roller 22 moves closer to and away from the photosensitive drum 21 as described above, but is positioned by the contact between the charging roller 22 and the photosensitive drum 21. Therefore, the rotation of the brush unit 40 in the arrow U direction caused by the urging force of the brush urging members 53 and 54 is stopped by the abutment between the non-drive-side position regulation portions 42k and 42m and the non-drive-side abutment portions 46a and 46b.

Here, two regulation surfaces (non-drive-side position regulation portions 42k and 42m) facing in different directions as viewed in the longitudinal direction (X direction) of the brush 41 are provided on the other end side (non-drive side) of the brush unit 40. In the case where the non-drive-side position regulation portion 42k is a first regulation surface, the non-drive-side position regulation portion 42m can be referred to as a second regulation surface. The non-drive-side position regulation portion 42k (first regulation surface) abuts a non-drive-side abutment portion 46a (first abutment portion) of the non-drive-side shaft receiver 46, and the non-drive-side position regulation portion 42m (second regulation surface) abuts a non-drive-side abutment portion 46b (second abutment portion) of the non-drive-side shaft receiver 46. As a result of this, the position of the brush unit 40 (position of the brush base 42) on the non-drive side can be determined at a high precision in a direction orthogonal to the longitudinal direction (X direction) of the brush 41.

More specifically, in the present embodiment, the position of the brush unit 40 is determined as a result of a protrusion shape of the non-drive-side shaft receiver 46 fitting in a recess shape (groove shape) defined by the non-drive-side position regulation portions 42k and 42m. In other words, the protrusion shape of the non-drive-side shaft receiver 46 including the non-drive-side abutment portions 46a and 46b are fit in a bottom portion 42v having a recess shape defined by the non-drive-side position regulation portions 42k and 42m. As a result of this, the brush unit 40 is positioned in a direction orthogonal to the longitudinal direction (X direction) of the brush 41.

As a result of the gap d2 provided between the support hole 42s and the support shaft 26b on the non-drive side (FIG. 12G), the protrusion shape of the non-drive-side shaft receiver 46 can be more reliably engaged with the recess shape formed by the non-drive-side position regulation portions 42k and 42m. That is, even in the case where the brush base 42 is slightly warped or twisted, since displacement of the support hole 42s with respect to the support shaft 26b is allowed by the gap d2, the protrusion shape of the non-drive-side shaft receiver 46 can be more reliably engaged with the recess shape of the brush base 42.

Incidentally, a situation in which only one of the non-drive-side position regulation portions 42k and 42m abuts the non-drive-side abutment portion 46a or 46b as illustrated in FIG. 12F in the course of rotation of the brush unit 40 about the support shafts 26a and 26b is possible. In the example of the FIG. 12F, the non-drive-side position regulation portion 42k and the non-drive-side abutment portion 46a abut each other, and the non-drive-side position regulation portion 42m and the non-drive-side abutment portion 46b are not in contact with each other.

However, the recess shape defined by the non-drive-side position regulation portions 42k and 42m is formed to recess toward the upstream side in the rotational direction (arrow U) in which the brush unit 40 rotates in accordance with the urging force of the brush urging members 53 and 54 about the support shafts 26a and 26b. Therefore, the protrusion shape of the non-drive-side shaft receiver 46 slides on the drive-side position regulation portion 42k toward the bottom portion 42v of the recess shape in accordance with the swing of the brush unit 40 in the swing direction indicated by the arrow U caused by the urging force of the brush urging members 53 and 54. As a result, even if a state illustrated in FIG. 12F is temporarily taken, a state in which the protrusion shape of the non-drive-side shaft receiver 46 is fit in the recess shape while in contact with both the non-drive-side position regulation portions 42k and 42m as illustrated in FIG. 12D is realized thereafter.

As described above, as a result of the regulation portion (drive-side position regulation portion 42j and the non-drive-side position regulation portions 42k and 42m) of the brush base 42 (holding member) abutting the shaft-supporting members (drive-side shaft receiver 45 and non-drive-side shaft receiver 46), the position of the brush base 42 is regulated. Since the position of the brush base 42 is regulated by the abutment between the regulation portion and the shaft-supporting member holding the charging roller 22, the brush 41 can be caused to contact the charging roller 22 with a more stable interference amount.

The interference amount of the brush 41 with respect to the charging roller 22 is a distance by which the position of the distal end of the brush bristles 41a in the case where it is assumed that the charging roller 22 is not present is pushed into a virtual cylinder surface following the actual surface 22a of the charging roller 22. For example, a difference between a sum of the outer diameter of the charging roller 22 and the protrusion amount (bristle height of the brush) of the brush bristles 41a with respect to the brush substrate (41b and 41c) and the minimum distance from the rotation axis of the charging roller 22 to the brush substrate (41b and 41c) of the brush 41 in the state of FIGS. 12B and 12C is defined as the interference amount of the brush 41.

Due to the dimensional tolerance of parts or the like, the interference amount of the brush 41 with respect to the charging roller 22 can vary between individual products or depending on the position in the longitudinal direction (X direction). In such a case, there is a possibility that the function of the brush 41 to scrape off the foreign matter attached to the surface 22a of the charging roller 22 deteriorates to cause an image defect. However, according to the present embodiment, the brush 41 can be caused to contact the charging roller 22 with a more stable interference amount. As a result of this, the charging performance of the charging roller 22 can be easily maintained for a longer period, and thus the possibility of occurrence of an image defect can be lowered.

Further, on the non-drive side, a configuration in which the gap d2 is provided between the support hole 42s and the support shaft 26b, and the position of the brush unit 40 is regulated by the abutment between the non-drive-side position regulation portions 42k and 42m and the non-drive-side abutment portions 46a and 46b is employed. As a result of this, for example, even in the case where the drum frame member 26 is twisted between the one end side and the other end side in the longitudinal direction (X direction) due to the dimensional tolerance of parts or variations in the assembly, the twist of the brush unit 40 can be suppressed. Further, the variation in the interference amount of the brush 41 with respect to the charging roller 22 can be reduced.

On the drive side, the drive-side position regulation portion 42j and the drive-side abutment portion 45a preferably have such shapes as to be in point contact with each other. As a result of this, even in the case where the surface of the drive-side position regulation portion 42j or the surface of the drive-side abutment portion 45a is inclined due to a shape error of the part or the like, change in the abutment position (hitting position) between the drive-side position regulation portion 42j and the drive-side abutment portion 45a can be suppressed. As a result, the variation in the interference amount of the brush 41 with respect to the charging roller 22 can be reduced more. Specifically, the drive-side abutment portion 45a of the present embodiment has a flat surface shape intersecting with a direction (direction orthogonal to the bristle-supporting portion 41b) in which the brush 41 moves closer to and away from the charging roller 22, and the drive-side position regulation portion 42j has an approximate arc shape as viewed in the longitudinal direction (X direction).

For a similar reason, on the non-drive side, the non-drive-side position regulation portion 42k and the non-drive-side abutment portion 46a preferably have such shapes as to be in point contact with each other, and the non-drive-side position regulation portion 42m and the non-drive-side abutment portion 46b preferably have such shapes as to be in point contact with each other. In the present embodiment, the non-drive-side position regulation portions 42k and 42m each have a flat surface shape, and the non-drive-side abutment portions 46a and 46b each have an approximate arc shape. In addition, the non-drive-side position regulation portions 42k and 42m are approximately orthogonal to each other as viewed in the longitudinal direction (X direction).

In the present embodiment, suppressing the twist of the brush unit 40 (twist of the brush base 42) by using the stiffness of the backing member 41c of the brush 41 has been described. In the case where a configuration to accept the twist of the brush unit 40 is employed, if the brush base 42 abuts only one of the drive-side shaft receiver 45 and the non-drive-side shaft receiver 46, the interference amount of the brush 41 with respect to the charging roller 22 varies. To avoid this situation, increasing the urging force of the brush urging members 53 and 54 can be considered, but there is a risk that the contact pressure of the charging roller 22 on the photosensitive drum 21 becomes uneven in the longitudinal direction (X direction). That is, there is a case where the difference in the urging force between the charging roller urging members 48 and 49 on the drive side and the non-drive side and the difference in the urging force between the brush urging members 53 and 54 on the drive side and the non-drive side are summed up and the contact pressure of the charging roller 22 on the photosensitive drum 21 varies. The variation in the contact pressure of the charging roller 22 on the photosensitive drum 21 can cause troubles such as unevenness in the potential of the photosensitive drum 21 and unevenness in the image density caused thereby, and biased wear of the photosensitive drum 21. Therefore, from the viewpoint of suppressing the variation in the contact pressure of the charging roller 22 on the photosensitive drum 21, the urging force of the brush urging members 53 and 54 is preferably low.

According to the present embodiment, since the twist of the brush unit 40 (twist of the brush base 42) is suppressed, the position precision of the brush 41 with respect to the charging roller 22 can be improved while making the urging force of the brush urging members 53 and 54 small.

In addition, in the present embodiment, a configuration in which the charging roller 22 is movable between the contacting position and the separation position with respect to the photosensitive drum 21 has been described. In this configuration, by regulating the position of the brush holding portion by causing the regulation portion of the brush unit 40 to abut the shaft-supporting member of the charging roller 22, the position precision of the brush holding portion with respect to the charging roller 22 can be improved while employing a configuration in which the charging roller 22 is movable.

According to the present embodiment, the brush unit 40 is moved in conjunction with the movement of the charging roller 22 between the contacting position and the separation position due to the abutment between the regulation portion and the shaft-supporting member. As a result of this, the charging roller 22 can be caused to contact and be separated from the photosensitive drum 21 without being interrupted by the brush unit 40.

### Details of Brush Electrical Contact

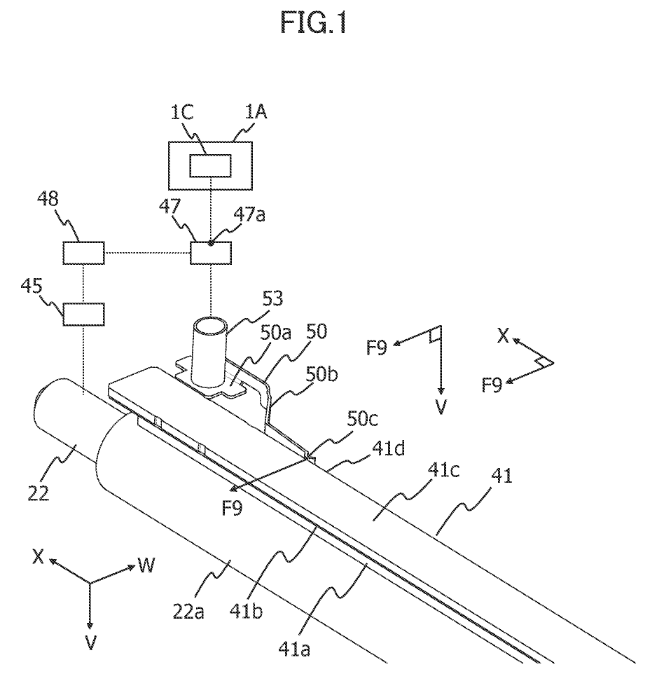

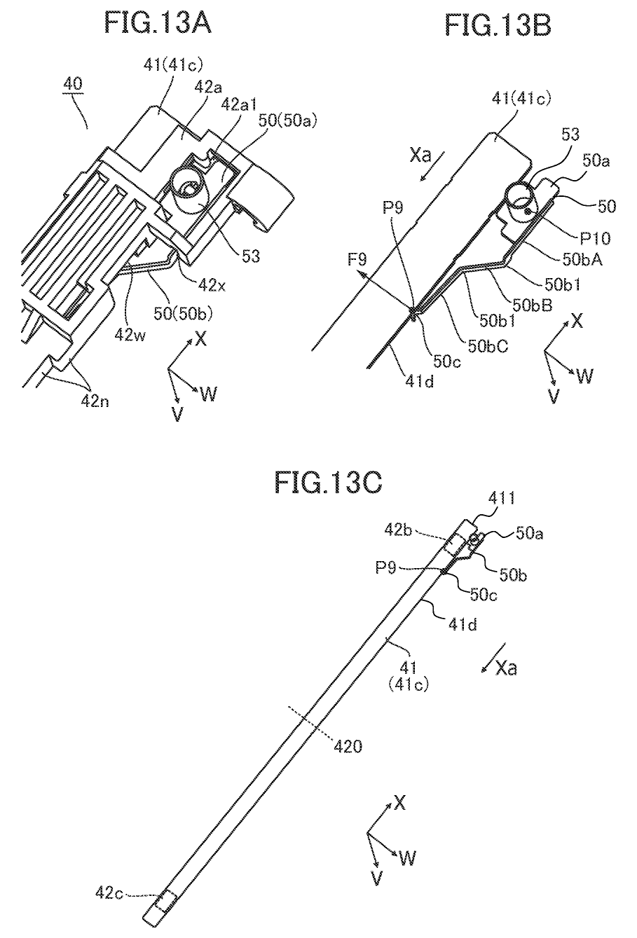

Details of the brush electrical contact 50 will be described with reference to FIGS. 1 and 13A to 13C. FIG. 1 is a perspective view of the brush 41, the brush electrical contact 50, the brush urging member 53, and the charging roller 22. FIG. 13A is a perspective view of part (near the brush electrical contact 50) of the brush unit 40. FIG. 13B is a perspective view in a case where the brush base 42 in FIG. 13A is seen through. FIG. 13C is a diagram illustrating the position of the brush electrical contact 50 with respect to the entirety of the brush 41.

As illustrated in FIGS. 1 and 13A, the brush electrical contact 50 of the present embodiment includes the first portion 50a, the second portion 50b, and the contacting portion 50c (contact portion) that contacts the brush 41. The brush electrical contact 50 is an example of a conduction member constituting at least part of a conduction path for applying a voltage to the brush 41.

The first portion 50a is accommodated in a recess portion 42a1 provided in the main unit portion 42a of the brush urging member 53, and is supported by the brush base 42 in the state of being sandwiched between a first end 53a of the brush urging member 53 and a bottom surface of the recess portion 42a1. The first portion 50a of the present embodiment has a flat surface shape intersecting with the thickness direction of the brush substrate (41b and 41c) of the brush 41 (height direction of the brush 41, V direction).

The second portion 50b is formed to be bent with respect to the first portion 50a in the thickness direction (V direction) of the brush substrate (41b and 41c) of the brush 41. In addition, the second portion 50b extends from the first portion 50a in a direction Xa from a drive-side end portion 411 (FIG. 13C) of the brush 41 toward a center 410 of the brush 41 in the longitudinal direction (X direction) of the brush 41. In other words, the brush electrical contact 50 serving as a contact member includes the second portion 50b extending from the first portion 50a toward the center side of the brush 41 in the rotation axis direction (X direction) of the charging roller 22.

The contacting portion 50c is provided at a distal end of the second portion 50b and contacts the brush substrate (41b and 41c) of the brush 41. In the present embodiment, the brush substrate (41b and 41c) includes the backing member 41c that is a metal plate member. The contacting portion 50c contacts the side surface 41d of the backing member 41c in the short-side direction (W direction) of the brush 41.

The brush electrical contact 50 (conduction member) of the present embodiment is electrically connected to a high-voltage board 1C of the apparatus body 1A via the brush urging member 53 (first urging member) and the charging roller electrical contact 47 (contact member) described above (FIG. 1). The high-voltage board 1C applies a voltage to the brush 41 via the charging roller electrical contact 47, the brush urging member 53, and the brush electrical contact 50. In addition, the high-voltage board 1C applies a voltage to the charging roller 22 via the drive-side shaft receiver 45 (shaft-supporting member), the charging roller urging member 48 (second urging member), and the charging roller electrical contact 47 (contact member). The voltages are applied such that the brush 41 and the charging roller 22 are at the same potential, and therefore it can be made easier to scrape off, by the brush 41, the foreign matter attached to the surface 22a of the charging roller 22 regardless of whether or not the foreign matter is charged as described above.

To be noted, the conduction path for applying a voltage to the brush 41 may be provided separately from the conduction path for applying a voltage to the charging roller 22. In addition, the voltage applied to the brush 41 does not have to be of a voltage value strictly equal to the charging voltage applied to the charging roller 22 as long as, for example, the voltage is of the same polarity as the charging voltage. In addition, in the case where, for example, a voltage waveform in which an alternate current component is superimposed on a direct current component is used as the charging voltage, a direct current voltage of the same voltage value as the direct current component may be applied to the brush 41. Also in these cases, an advantage of improving the performance to scrape off the foreign matter as compared with a case where no voltage is applied to the brush 41 can be obtained at least partially.

The first contact portion 47a of the charging roller electrical contact 47 is an example of an exposed contact portion exposed to the outside of the process unit 20. In addition, the charging roller electrical contact 47 including the first contact portion 47a is an example of a contact member.

In the present embodiment, both the charging roller 22 and the brush 41 are electrically connected to the first contact portion 47a (exposed contact portion) of the charging roller electrical contact 47. Therefore, the image forming apparatus 1 including the process unit 20 can make the potentials of the charging roller 22 and the brush 41 equal by applying the same voltage to both the charging roller 22 and the brush 41 via the first contact portion 47a.

### Direction of Force Acting from Brush Electrical Contact to Brush Substrate

Here, the direction of the force (contacting force F9) acting from the contacting portion 50c of the brush electrical contact 50 to the brush substrate (41b and 41c) of the brush 41 and deformation of the brush substrate (41b and 41c) of the brush 41 will be described. In the present embodiment, the contacting force F9 is a force by which the contacting portion 50c of the brush electrical contact 50 presses the side surface 41d of the backing member 41c.

To cause the brush electrical contact 50 to more reliably contact the brush substrate (41b and 41c) of the brush 41, the brush electrical contact 50 is configured such that the contacting portion 50c contacts the brush substrate (41b and 41c) by a predetermined contacting force F9. For example, as will be described later, the contacting force F9 is generated by imparting springiness by the bent shape of the brush electrical contact 50 that is a metal plate member.

A comparative example in which the contacting force F9 is parallel to the thickness direction (V direction) of the brush 41 will be considered. In this case, there is a possibility that deformation of the brush base 42 (deformation of the main unit portion 42a) occurs such that the main unit portion 42a is warped toward the charging roller 22 side or toward the opposite side thereto in the thickness direction (V direction) in the vicinity of the contacting portion 50c. In the case where such deformation of the main unit portion 42a occurs, there is a case where the interference amount of the brush 41 with respect to the charging roller 22 is inconsistent between positions in the longitudinal direction (X direction) of the brush 41. As a result, there is a possibility that the function of the brush 41 to scrape off the foreign matter attached to the surface 22a of the charging roller 22 deteriorates.

In contrast, according to the present embodiment, as illustrated in FIG. 1, the direction of the contacting force F9 by which the contacting portion 50c presses the brush substrate (41b and 41c) of the brush 41 intersects with the thickness direction (V direction) of the brush substrate (41b and 41c). Therefore, in the case where the value of the contacting force F9 is equal to that of the comparative example described above, the external force acting on the brush substrate (41b and 41c) of the brush 41 in the thickness direction (V direction) is smaller in the present embodiment.

Therefore, according to the present embodiment, deformation of the main unit portion 42a (brush holding portion) in the thickness direction (V direction) of the brush substrate (41b and 41c) can be suppressed. As a result, the brush 41 can be caused to contacts the charging roller 22 with a more stable interference amount regardless of the position in the longitudinal direction (X direction). Further, by scraping off the foreign matter attached to the surface 22a of the charging roller 22 by the brush 41, good image quality can be maintained for a long period of time.

The direction of the contacting force F9 is preferably orthogonal to the thickness direction (V direction) of the brush substrate (41b and 41c). In addition, the direction of the contacting force F9 in the present embodiment is also orthogonal to the longitudinal direction (X direction) of the brush 41.

To be noted, since the brush substrate (41b and 41c) has a plate shape orthogonal to the thickness direction (V direction), the stiffness of the brush substrate against the external force in the short-side direction (W direction) and the longitudinal direction (X direction) of the brush 41 is higher than the stiffness of the brush substrate against the external force in the thickness direction (V direction). Therefore, components of the contacting force F9 in the short-side direction (W direction) and the longitudinal direction (X direction) of the brush 41 are received by the stiffness of the brush substrate (41b and 41c), and thus the brush substrate (41b and 41c) is less likely to be deformed.

The positional relationship between the brush electrical contact 50 and the position where the brush base 42 holds the brush substrate (41b and 41c) of the brush 41 will be further described. As illustrated in FIG. 13C, in the longitudinal direction (X direction) of the brush 41, a point of action P9 of the contacting force acting from the contacting portion 50c of the brush electrical contact 50 to the backing member 41c is disposed between brush placement surfaces 42b and 42c of the main unit portion 42a to which the brush substrate (41b and 41c) of the brush 41 is fixed.

The brush placement surface 42b is an example of a first regulation portion that regulates the position of the brush substrate in the thickness direction (V direction) of the brush substrate (41b and 41c) on the first end side (drive side) of the brush 41 with respect to the center 410 of the brush 41 in the rotation axis direction (X direction) of the charging roller 22. The brush placement surface 42c is an example of a second regulation portion that regulates the position of the brush substrate in the thickness direction (V direction) of the brush substrate (41b and 41c) on the second end side (non-drive side) of the brush 41 with respect to the center 410 of the brush 41 in the rotation axis direction (X direction) of the charging roller 22.

To be noted, the brush substrate (41b and 41c) of the present embodiment is fixed to the brush placement surfaces 42b and 42c by, for example, gluing the backing member 41c to the brush placement surfaces 42b and 42c by using an adhesive, but the position of the brush substrate (41b and 41c) may be regulated by a method different from gluing. For example, a configuration in which the positions of the end portions in the longitudinal direction of the brush substrate in the thickness direction (V direction) of the brush substrate (41b and 41c) are regulated by inserting the end portions in the longitudinal direction of the backing member 41c into slits provided at end portions in the longitudinal direction of the brush base 42.

Incidentally, causing the contacting portion 50c of the brush electrical contact 50 to contact an end portion (for example, the drive-side end portion 411 illustrated in FIG. 13C) of the brush substrate (41b and 41c) in the longitudinal direction (X direction) of the brush 41 can be also considered. However, as illustrated in FIG. 6, for example, the charging roller urging member 48 that urges the drive-side shaft receiver 45 of the charging roller 22 is disposed on the outside of the brush 41 in the longitudinal direction (X direction). If the position of the charging roller urging member 48 is changed to a position further outward in the longitudinal direction (X direction) to avoid interference with the brush electrical contact 50, the positions and shapes of the drive-side shaft receiver 45 and the charging roller electrical contact 47 need to be also changed, which leads to increase in the size of the drum unit 25.

In contrast, in the present embodiment, the brush electrical contact 50 can be disposed while avoiding the increase in the size of the drum unit 25, by using a space on one side of the brush 41 in the short-side direction (W direction) that is relatively large.

### Details of Shape of Brush Electrical Contact

The second portion 50b of the present embodiment includes three small portions (erecting portion 50bA, inclined portion 50bB, and distal end portion 50bC) bent at two bent portions 50b1 (FIG. 13B).

The erecting portion 50bA is bent with respect to the first portion 50a so as to erect approximately orthogonally from the first portion 50a, and extends approximately parallel to the longitudinal direction (X direction) of the brush 41. In addition, the erecting portion 50bA is disposed at a position away from the side surface 41d in the short-side direction (W direction) of the backing member 41c with the first portion 50a and the brush urging member 53 therebetween in the short-side direction (W direction) of the brush 41.

The inclined portion 50bB is connected to the erecting portion 50bA, and is bent with respect to the erecting portion 50bA at the bent portion 50b1. The inclined portion 50bB extends in a direction inclined with respect to the longitudinal direction (X direction) of the brush 41 so as to be closer to the side surface 41d of the backing member 41c in the short-side direction (W direction) toward the center side in the longitudinal direction (X direction) of the brush 41.

The distal end portion 50bC is connected to the inclined portion 50bB, and is bent with respect to the inclined portion 50bB at the bent portion 50b1. The distal end portion 50bC extends toward the center side of the brush 41 in the longitudinal direction (X direction) along the side surface 41d at an angle closer to parallel to the side surface 41d than the inclined portion 50bB.

By forming the bent shape described above in the second portion 50b of the brush electrical contact 50, the second portion 50b can be imparted with elasticity (springiness) to urge the contacting portion 50c toward the side surface 41d of the backing member 41c. In other words, the brush electrical contact 50 is configured such that the contacting portion 50c is in pressure contact with the side surface 41d of the backing member 41c with a predetermined interference amount. The interference amount of the contacting portion 50c is a distance in the short-side direction (W direction) of the brush 41 by which the position of the contacting portion 50c in the case where it is assumed that the backing member 41c is not present bites into the side surface 41d of the actual backing member 41c. To be noted, the bent shape described above is merely an example, and the specific shape of the brush electrical contact 50 can be changed.

To be noted, as illustrated in FIG. 13A, the brush base 42 is provided with opening portions 42x and 42w to allow the brush electrical contact 50 therethrough (also see FIGS. 10A and 10B). The opening portion 42x is formed on the inside of the recess portion 42a1, which accommodates the first portion 50a of the brush electrical contact 50, and penetrates to the outside of the recess portion 42a1. The second portion 50b (erecting portion 50bA) of the brush electrical contact 50 protrudes from the inside to the outside of the recess portion 42a1 through the opening portion 42x. The opening portion 42w is formed in a wall portion 42u of the brush base 42 opposing the side surface 41d of the backing member 41c of the brush 41, and penetrates from the inside (backing member 41c side) to the outside of the wall portion 42u in the short-side direction (W direction) of the brush 41. The second portion 50b (inclined portion 50bB and distal end portion 50bC) of the brush electrical contact 50 extends from the outside to the inside of the wall portion 42u through the opening portion 42w, and opposes the side surface 41d of the backing member 41c.

By providing the opening portions 42x and 42w, the brush urging member 53 can be easily attached to the brush base 42 while employing a configuration in which the first portion 50a that comes into contact with the brush urging member 53 to the contacting portion 50c that contacts the brush 41 are integrally formed in the brush electrical contact 50. To be noted, the positions and shapes of the opening portions 42x and 42w can be changed in accordance with the specific configuration of the brush base 42 and the brush electrical contact 50, or the opening portions 42x and 42w may be omitted in some cases.

### Modification Examples

A case where end portions of the brush substrate (41b and 41c) of the brush 41 are held by the brush placement surfaces 42b and 42c (first regulation portion and second regulation portion) of the brush base 42 has been described in the embodiment described above. However, the method to hold the brush substrate (41b and 41c) by the brush base 42 (holding member) is not limited to this. For example, the entirety of the surface of the brush substrate (41b and 41c) on the side opposite to the brush bristles 41a in the thickness direction of the brush substrate (41b and 41c) may be glued to the brush base 42. Also in this case, if the direction of the contacting force F9 is parallel to the thickness direction (V direction) of the brush substrate (41b and 41c), there is a possibility that the brush substrate (41b and 41c) deforms together with the brush base 42 especially in the case where the stiffness of the brush base 42 is low. In contrast, if the direction of the contacting force F9 intersects with the thickness direction (V direction) of the brush substrate (41b and 41c), the deformation of the brush substrate (41b and 41c) is less likely to occur.

In addition, a case where the contacting portion 50c of the brush electrical contact 50 contacts the brush substrate (41b and 41c) at a position between the brush placement surfaces 42b and 42c holding the end portions of the brush substrate (41b and 41c) of the brush 41 has been described in the embodiment described above. However, the contacting portion 50c may be disposed to contact the brush substrate (41b and 41c) at the same position as one of the brush placement surfaces 42b and 42c in the longitudinal direction (X direction) of the brush 41. In addition, in the case where, for example, end portions of the brush substrate (41b and 41c) in the longitudinal direction (X direction) of the brush 41 protrude more outward than the brush placement surfaces 42b and 42c, the contacting portion 50c may contact the brush substrate (41b and 41c) at a position more outward than the brush placement surfaces 42b and 42c. Also in these modification examples, there is a possibility that the brush substrate (41b and 41c) deforms depending on the stiffness of the brush base 42 if the direction of the contacting force F9 is parallel to the thickness direction (V direction) of the brush substrate (41b and 41c). In contrast, if the direction of the contacting force F9 intersects with the thickness direction (V direction) of the brush substrate (41b and 41c), the deformation of the brush substrate (41b and 41c) is less likely to occur.

In addition, although an example in which the direction of the contacting force F9 is orthogonal to the thickness direction (V direction) of the brush substrate (41b and 41c) has been described in the embodiment described above, a similar advantage can be obtained as long as the direction of the contacting force F9 intersects with the thickness direction (V direction). That is, if the direction of the contacting force F9 intersects with the thickness direction (V direction), the brush 41 can be caused to contact the charging roller 22 with a more stable interference amount regardless of the position in the longitudinal direction than at least in the case where the direction of the contacting force F9 is parallel to the thickness direction (V direction).

To be noted, to make the deformation of the main unit portion 42a in the thickness direction (V direction) of the brush substrate (41b and 41c) smaller, it is preferable that the direction of the contacting force F9 intersects with the thickness direction (V direction) at an angle close to 90°. The angle by which the direction of the contacting force F9 intersects with the thickness direction (V direction) is, for example, preferably 45° or more, more preferably 60° or more, and further preferably 75° or more. Here, the angle by which the direction of the contacting force F9 intersects with the thickness direction (V direction) is the angle of two smaller angles among four angles formed at a crossing point between a first imaginary straight line extending in the direction of the contacting force F9 and a second imaginary straight line extending in the thickness direction (V direction) and intersecting with the first imaginary straight line.

A configuration in which the position of the brush 41 with respect to the charging roller 22 is regulated by the brush base 42 of the brush unit 40 abutting the drive-side shaft receiver 45 and the non-drive-side shaft receiver 46 has been described in the embodiment described above. The configuration is not limited to this, and for example, a configuration in which the position of the brush 41 with respect to the charging roller 22 is regulated by the backing member 41c of the brush 41 abutting the drive-side shaft receiver 45 and the non-drive-side shaft receiver 46 may be employed.

### Other Embodiments

In the embodiment described above, the image forming apparatus 1 of a direct transfer system in which the toner image is transferred from the image bearing member (photosensitive drum 21) onto the recording material P serving as a transfer target has been described as an example. The configuration is not limited to this, and the technique of the present disclosure may be applied to an image forming apparatus of an intermediate transfer system in which a toner image is transferred from an image bearing member (photosensitive drum 21) onto an intermediate transfer member serving as a transfer target through primary transfer and then the toner image is transferred from the intermediate transfer member onto the recording material P. In addition, the technique of the present disclosure is not limited to a monochromatic image forming apparatus, and may be applied to a color image forming apparatus using toners of a plurality of colors.

Although the image forming apparatus 1 including the process unit 20 of a cleanerless type has been described in the above embodiment, the process unit 20 may include a cleaning member such as a cleaning blade that collects (removes) transfer residual toner from the photosensitive drum 21. Also in this case, there is a possibility that a foreign matter that passes through the cleaning member and reaches the charging portion Q1, a foreign matter taken into the image forming apparatus 1 with outside air, and the like can attach to the charging roller 22. Therefore, also in a configuration in which the process unit 20 includes a cleaning member, the occurrence of an image defect caused by attachment of a foreign matter to the charging roller 22 can be reduced by providing the brush unit 40 described in the embodiment.

According to the technique of the present disclosure described in the above-described embodiment as an example, a process unit and an image forming apparatus capable of suppressing an image defect caused by a foreign matter attached to the charging roller can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-177380, filed October 9, 2024, which is hereby incorporated by reference herein in its entirety.

WHAT IS CLAIMED IS:

1. A process unit comprising:
a rotatable image bearing member;
a charging roller configured to come in contact with a surface of the image bearing member and configured to charge the surface; and
a brush unit including (i) a brush including (i-1) a plate-shaped brush substrate and (i-2) brush bristles protruding from the brush substrate and configured to come into contact with a surface of the charging roller, (ii) a holding member configured to hold the brush substrate and regulate a position of the brush substrate, and (iii) a conduction member through which a voltage is applied to the brush,
wherein the conduction member includes a contacting portion configured to contact the brush substrate, and is configured such that a direction in which the contacting portion applies a force to the brush substrate intersects with a thickness direction of the brush substrate.

2. The process unit according to claim 1,
wherein the contacting portion is configured to contact a side surface of the brush substrate in a direction orthogonal to both a rotation axis direction of the charging roller and the thickness direction.

3. The process unit according to claim 1,
wherein the brush substrate includes a bristle-supporting portion configured to support the brush bristles, and a metal plate member configured to support the bristle-supporting portion, and
wherein the contacting portion is configured to contact the metal plate member.

4. The process unit according to claim 1,
wherein the direction of the force that the contacting portion applies to the brush substrate is orthogonal to the thickness direction.

5. The process unit according to claim 1,
wherein the holding member includes a first regulation portion and a second regulation portion, the first regulation portion being configured to regulate a position of the brush substrate in the thickness direction on a first end side of the brush with respect to a center of the brush in a rotation axis direction of the charging roller, the second regulation portion being configured to regulate the position of the brush substrate in the thickness direction on a second end side opposite to the first end side with respect to the center, and
wherein the contacting portion is configured to contact the brush substrate at a position between the first regulation portion and the second regulation portion in the rotation axis direction.

6. The process unit according to claim 5,
wherein the holding member includes an opposing surface opposing the brush substrate in the thickness direction of the brush substrate,
wherein the opposing surface includes a first placement surface portion to which one end portion of the brush substrate in the rotation axis direction is fixed, a second placement surface portion to which another end portion of the brush substrate in the rotation axis direction is fixed, and a non-fixed portion which is formed in a region between the first placement surface portion and the second placement surface portion in the rotation axis direction and to which the brush substrate is not fixed, and
wherein the first regulation portion is the first placement surface portion, and the second regulation portion is the second placement surface portion.

7. The process unit according to claim 1, further comprising:
a frame member configured to support the brush unit; and
an urging member configured to urge the holding member in such a direction that the brush substrate moves closer to the charging roller,
wherein the conduction member includes a first portion interposed between the urging member and the holding member, and receives application of the voltage via the urging member.

8. The process unit according to claim 7,
wherein the conduction member is formed from a metal plate,
wherein the first portion has a flat surface shape intersecting with the thickness direction of the brush substrate,
wherein the conduction member includes a second portion bent in the thickness direction with respect to the first portion and extending from the first portion toward a center side of the brush in a rotation axis direction of the charging roller, and
wherein the contacting portion is provided at a distal end of the second portion and pressed against the brush substrate by elasticity of the second portion.

9. The process unit according to claim 1, further comprising:
an exposed contact portion exposed to an outside of the process unit,
wherein the exposed contact portion is electrically connected to both the conduction member and the charging roller.

10. The process unit according to claim 9, further comprising:
a contact member provided with the exposed contact portion;
a shaft-supporting member configured to rotatably support the charging roller;
a frame member configured to support the shaft-supporting member and the brush unit;
a first urging member disposed between the frame member and the holding member and configured to urge the holding member in such a direction that the brush substrate moves closer to the charging roller; and
a second urging member disposed between the frame member and the shaft-supporting member and configured to urge the shaft-supporting member in such a direction that the charging roller moves closer to the image bearing member,
wherein the contact member is attached to the frame member, electrically connected to the conduction member via the first urging member, and electrically connected to the charging roller via the second urging member and the shaft-supporting member.

11. The process unit according to claim 1,
wherein in a case where the brush unit is referred to as a first brush unit,
the process unit includes a second brush unit configured to collect a foreign matter attached to the image bearing member, and
the second brush unit includes a brush configured to come into contact with the surface of the image bearing member at a position downstream of a transfer portion and upstream of a charging portion in a rotation direction of the image bearing member in image formation, the transfer portion being a portion where an image is transferred from the image bearing member to a transfer target, the charging portion being a portion where the image bearing member opposes the charging roller.

12. The process unit according to claim 1, further comprising:
a developing unit including a toner storage portion configured to store toner, and a developing roller configured to bear the toner to supply the toner to the image bearing member,
wherein the process unit is configured to collect, to the toner storage portion and by the developing roller, the toner not transferred from the image bearing member to a transfer target.

13. An image forming apparatus comprising:
the process unit according to claim 1; and
an apparatus body,
wherein the image forming apparatus is configured to form an image on a recording material by using the process unit attached to the apparatus body.
